(19) United States
(12) Patent Application Publication
(10) Pub. No.: US 2008/0136160 A1
(43) Pub. Date: Jun. 12, 2008

(54) METHOD OF PRODUCING AN INFORMATION CARRIER

(75) Inventor: Luc Leenders, Herentals (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: AGFA-GEVAERT, Mortsel (BE)

(21) Appl. No.: 11/738,083

(22) Filed: Apr. 20, 2007

Related U.S. Application Data
(60) Provisional application No. 60/869,607, filed on Dec. 12, 2006.
(60) Provisional application No. 60/908,533, filed on Mar. 28, 2007.

(30) Foreign Application Priority Data
Dec. 7, 2006 (EP) 06125558.4
Mar. 27, 2007 (EP) 07104954.8

(51) Int. Cl. B42D 15/00

(52) U.S. Cl. 283/72

(57) ABSTRACT

Methods for producing an information carrier comprising the steps of: (1) providing an information carrier precursor comprising: a rigid sheet or support; a receiving layer configuration comprising at least one constituent layer; and a layer or element capable of a human-readable or machine-readable change upon absorbing UV, visible or IR radiation, wherein at least one layer of the receiving layer configuration is opaque, porous, has the capability of being rendered substantially transparent upon penetration by a lacquer provided at the outermost surface of the receiving layer configuration and comprises at least one pigment and at least one binder; (2) realizing a temporary transparentization pattern by applying a vaporizable liquid pattern-wise or integrally to the receiving layer configuration; (3) writing with a light source a first pattern in the layer or element capable of human readable or machine-readable change; and in any order evaporating the vaporizable liquid; applying a second pattern to the outermost layer of the receiving layer configuration; and realizing a permanent transparentization pattern by applying a lacquer pattern-wise or integrally to the receiving layer configuration; with the proviso that the lacquer is applied after the vaporizable liquid has been evaporated, thereby producing an information carrier.

### CROSS-REFERENCE TO RELATED PATENT APPLICATIONS

This application claims the benefit of U.S. Provisional Application No. 60/869,607 filed Dec. 12, 2006; and U.S. Provisional Application No. 60/908,533 filed Mar. 28, 2007, which are both incorporated by reference. In addition, this application claims the benefit of European Application No. 06125558 filed Dec. 7, 2006; and European Application No. 07104954 filed Mar. 27, 2007, which are also incorporated by reference.

### FIELD OF THE INVENTION

The present invention relates to a method for producing an information carrier.

### BACKGROUND OF THE INVENTION

The security field encompasses not only personalized documents such as passports, driving licenses, identity cards (ID cards) and admission documents such as visa's and entry tickets, but also the authentification and identification of goods to avoid counterfeiting, tampering and fraud such as lottery tickets, share certificates, transaction documents, labels on luggage and the packaging of pharmaceuticals and high value products in general.

The term “identity card” encompasses cards requiring bearer identification and range from national identity cards to establish the national identity of their civilians to cards involved in the electronic transfer of money such as bank cards, pay cards, credit cards and shopping cards to security cards authorizing access to the bearer of the card to particular areas such as a company (employee ID card), the military, a public service, the safe deposit departments of banks, etc. to social security cards to membership cards of clubs and societies.

ID cards usually contain information referring both to the authority issuing the card on the one hand and to the owner of the card on the other. The first type of information may be general information such as a name and/or logo of the issuing authority, or security marks, such as a watermark and security print, e.g. a repeating monochrome pattern or a gradually changing colour pattern which are difficult to counterfeit. The second type includes e.g. the unique card number, personal data such as a birth day, a photo of the owner, and a signature. The card can further contain hidden information and therefore contain a magnetic strip or an electronic chip (“smart cards”).

A large set of ID cards are usually prepared on a large web or sheet by a step and repeat process, after which the web or sheet is cut into multiple items with the appropriate dimensions each representing a personal ID card. Smart cards and ID cards have now the standardized dimensions of 85.6 mm×54.0 mm×0.76 mm.

Normally, the card is protected by a plastic sheet material for example by lamination of the card to a plastic sheet or, as is usually the case, by lamination between two plastic sheets.

In view of their widespread uses, particularly in commercial transactions such as cashing cheques, credit purchases etc., it is important that the person relying on the ID card to identify the bearer have maximum assurance that the ID card has not been altered and/or that the ID card is not a counterfeit.

The art's response to the counterfeiting problem has involved the integration of “verification features” with ID cards to evidence their authenticity. The best known of these “verification features” involve signatures such as the signature of the one authorized to issue the ID card or the signature of the bearer. Other “verification features” have included the use of watermarks, fluorescent materials, validation patterns or markings and polarizing stripes. These “verification features” are integrated into ID cards in various ways and they may be visible or invisible in the finished card. If invisible, they can be detected by viewing the feature under conditions which render it visible. Details relating to the use of “verification features” in ID cards can be found in U.S. Pat. No. 2,984,030, U.S. Pat. No. 3,279,826; U.S. Pat. No. 3,332,775, U.S. Pat. No. 3,414,998, U.S. Pat. No. 3,675,948, U.S. Pat. No. 3,827,726 and U.S. Pat. No. 3,961,956.

EP-A 0 190 997 discloses a process for the marking of high molecular organic materials containing at least one radiation sensitive discoloration-causing additive, characterized in that laser-light, whose wavelength is in the UV- or near IR-ranges, is used as the energy radiation and the additive is at least one inorganic and/or organic pigment and/or a polymer-soluble dye.

U.S. Pat. No. 4,032,691 discloses a recording material which comprises a support having thereon a highly thermally insulating porous resin layer and a metal, dye or synthetic resin which is thermally deformed, foams, colors, discolors, sublimes, evaporates, or becomes transparent, translucent or opaque when exposed to radiation having a high energy density.

U.S. Pat. No. 4,180,405 discloses a mixture of heat-sensitive color precursors comprising (a) a cyclic polyketo compound reactive with amines and amides at elevated temperatures to form a color; and (b) a chromogenic compound selected from the group consisting of lactone type leuco dyes and spiropyran type leuco dyes, said chromogenic compound being reactive with phenols at elevated temperatures to form a color.

U.S. Pat. No. 4,401,992 discloses a method of marking an object having a synthetic resin surface by causing a color contrast pattern to be formed in said surface by exposure of said surface to a laser beam, characterized in that present in said surface is a colored inorganic silicate pigment or a mixture of a dye and a silicate glass and that desired areas of said surface are exposed to a laser beam having an intensity of at least 1000 kW/cm², measured on said surface, thereby decomposing said inorganic silicate pigment or said dye at said exposed areas and thereby changing the color of said exposed areas of said surface.

U.S. Pat. No. 4,578,329 discloses an article having at least a polyolefin surface, provided with a mark obtained by exposing said surface to the action of a laser beam, wherein the polyolefin comprises a nondye laser radiation absorbing substance in an amount sufficient for decomposing the poly-olefin by the laser beam energy.

EP-A 0 697 433 discloses a laser markable thermoplastic composition, comprising: (a) at least one thermoplastic resin composition suitable for laser marking; and (b) at least one copper salt selected from the group consisting of copper phosphate, copper sulphate, cupric hydroxide phosphate and copper thiocyanate, wherein said copper salt is present in an amount sufficient to cause said laser markable thermoplastic composition to absorb a laser light outside the visible spectrum such that the portion of said composition which absorbs said laser light has a visibly distinct and separately identifiable color.

WO 94/12352A discloses a polymer composition comprising a polymer and a radiation sensitive substance, which can be modified by means of irradiation in such a way that after the irradiation the part of the surface of the polymer composition that has been subjected to irradiation has a colour that differs from the colour of the surface, characterized in that the radiation sensitive substance absorbs radiation in the visible range, the near infra-red region and/or the near ultra-violet region, can be modified in different ways, so that on the surface of the polymer composition several, mutually different chromatic colours can be obtained.

WO 01/38103A discloses a polymer composition with improved laser markability, containing a polymer matrix material and at least one radiation-sensitive dye, characterised in that the radiation-sensitive dye can change colour via a photo-thermal process by irradiation with laser light and is present in concentrated form in separate domains.

WO 06/039249A1 discloses a method of marking a thermoplastic article, comprising: combining a thermoplastic with a light-marking additive to form a composition; forming the composition into an article having a maximum optical absorption wavelength; and illuminating, at a marking wavelength, at least a portion of the article with a device having a power of less than or equal to about 200 mW, to form a light-mark having a size, as measured along a major axis, of greater than or equal to about 10 micrometers; wherein light-mark has a mark absorption wavelength that is greater than or equal to about ±100 nm of the maximum optical absorption wavelength; and wherein the light-mark has a spectral absorption curve.

U.S. Pat. No. 6,888,095 discloses a method for marking an object, wherein the object comprises a material including a functional group and a metal compound or acid that reacts with the functional group and causes an elimination reaction on irradiation with a laser, to form a reaction product of contrasting colour, which comprises directing a laser beam on to the areas of the object to be marked, whereby those areas are marked by the presence of said reaction product.

WO 2005/068207A1 discloses an ink formulation comprising a marking component and a metal salt that absorbs laser irradiation at 700-2000 nm and thereby causes the marking component to change colour.

WO 2006/051309A1 discloses a colourless or transparent composition comprising a charge-delocalization compound and a photoacid, wherein the photoacid generates an acid on irradiation or heating, thereby forming a coloured change-transfer complex with said compound.

WO 2006/018640A1 discloses a method for forming an image on a substrate, which comprises applying to the substrate a combination of a diacetylene and a photoacid or photobase, and polymerising the diacetylene by radiation.

U.S. Pat. No. 6,645,280 discloses an ink composition comprising a slow evaporating solvent and a translucentizing agent, wherein the ink composition is free or substantially free of colorants and is suitable for use in ink jet printing on paper substrates, and the slow evaporating solvent is present in an amount of from about 15% by weight to about 70% by weight of the ink composition, the translucentizing agent making the paper less opaque, and thus forming a visible image on the paper when viewed under light and typically, the translucentizing agent has a refractive index of from about 1.3 (±0.05) to about 1.7, and preferably from about 1.4 to about 1.6, at 20° C.

U.S. Pat. No. 6,358,596 discloses a cellulosic substrate having at least one transparentized portion formed therein, wherein said cellulosic substrate defines first and second major faces; said transparentized portion comprises a transparentizing composition applied to said cellulosic substrate in a predetermined pattern so as to define a graphical image having a relative transparency selected so as to define an area of increased transparency in said substrate; said area of increased transparency resembles a graphical watermark and defines a degree of transparency that excludes the degree of transparency defined by a transparent window; said transparentizing composition comprises a transparentizing agent and a security agent. The radiation curable transparentizing composition disclosed in U.S. Pat. No. 6,358,596 comprises at least one monomer selected from the group consisting of acrylate or methacrylate esters of polyhydroxy polyethers made from polyhydric alcohols (polyols) starting materials (compounds of Formula I) and/or acrylate or methacrylate esters of polyhydroxy polyethers made from primary or secondary amine starting materials (compounds of Formula II).

EP-A 1 362 710 discloses a method for producing a tamper proof carrier of information, said method comprising the following steps, in order: (1) providing a two-layer assemblage comprising (i) a rigid sheet or web support, and (ii) a porous opaque ink receiving layer comprising a pigment and a binder whereby either the surface of said support, or the surface of said opaque layer carries a first set of printed information, (2) printing a second set of information, different from said first set, onto said porous opaque ink receiving layer by means of ink jet printing, (3) covering totally, partially, or pattern-wise the thus obtained assemblage with a UV-curable lacquer composition, by means of coating, printing, spraying or jetting, whereby on penetration of the lacquer in said porous opaque ink receiving layer this layer becomes substantially transparent, (4) curing said lacquer composition by means of an overall UV exposure, thereby improving the adhesion between said support and said ink receiving layer, and the cohesive strength of said ink receiving layer.

EP-A 1 398 175 discloses four different embodiments of an information carrier. In the first embodiment the information carrier comprising: a rigid sheet or web support; an opaque porous receiving layer capable of being rendered substantially transparent by penetration by a lacquer, said receiving layer containing a pigment and a binder; an image provided onto and/or in said receiving layer; a cured pattern of a varnish provided onto said receiving layer provided with said image or onto and/or in said receiving layer provided with said image if said varnish is incapable of rendering said receiving layer transparent; and a cured layer of said lacquer provided on said receiving layer provided with said image and said cured pattern of said varnish, said lacquer having rendered said parts of said receiving layer in contact therewith substantially transparent, wherein said cured pattern of said varnish forms an opaque watermark. In the second embodiment the information carrier comprising: a rigid sheet or web support; an opaque porous receiving layer capable of being rendered substantially transparent by penetration by a varnish, said receiving layer containing a pigment and a binder; an image provided onto and/or in said receiving layer; a cured pattern of said varnish provided in said receiving layer provided with said image; and a cured layer of a lacquer provided onto said receiving layer provided with said image and said cured pattern of said varnish, or onto and/or in said receiving layer provided with said image and said cured pattern of said varnish if said lacquer is incapable of rendering said receiving layer transparent, said varnish having rendered said parts of said receiving layer in contact therewith substantially transparent, wherein said cured pattern of said lacquer forms a substantially transparent watermark. In the third embodiment the information carrier comprising: a rigid sheet or web support; a transparent porous receiving layer capable of being rendered substantially opaque by penetration by a lacquer, said receiving layer containing a pigment and a binder; an image provided onto and/or in said receiving layer; a cured pattern of a varnish provided onto said receiving layer provided with said image, or onto and/or in said receiving layer provided with said image if said varnish is incapable of rendering said receiving layer opaque; and a cured layer of said lacquer provided on said receiving layer provided with said image and said cured pattern of said varnish, said lacquer having rendered said parts of said receiving layer in contact therewith substantially opaque, wherein said cured pattern of said varnish forms a transparent watermark. In the fourth embodiment the information carrier comprising: a rigid sheet or web support; a transparent porous receiving layer capable of being rendered substantially opaque by penetration by a varnish, said receiving layer containing a pigment and a binder; an image provided onto and/or in said receiving layer; a cured pattern of said varnish provided in said receiving layer provided with said image; and a cured layer of a lacquer provided onto said receiving layer provided with said image and said cured pattern of said varnish, or onto and/or in said receiving layer provided with said image and said cured pattern of said varnish if said lacquer is incapable of rendering said receiving layer opaque, said varnish having rendered said parts of said receiving layer in contact therewith substantially opaque, wherein said cured pattern of said lacquer forms a substantially opaque watermark.

GB 1 073 433 discloses the method of forming an image on a porous, opaque layer comprising applying an imaging material in imagewise configuration which is of similar refractive index to the opaque layer and reducing the viscosity of said imaging material so that it flows into the pores to fill the pores of said opaque layer to render said opaque layer clear in said image areas.

U.S. Pat. No. 4,252,601 discloses an information recording kit for making transparencies for projection of information or for making photographic negatives for reproductions comprising an opaque recording material, a writing liquid for recording information on the recording material and means for applying the writing liquid on the opaque recording material in the form of transparent lines wherein said recording material comprises a transparent backing sheet and an opaque layer adhered to one surface of said backing sheet, said opaque layer comprising a finely divided particulate organic styrene resin pigment uniformly distributed throughout a polyvinylidene chloride film-forming resin binder, said writing liquid comprising a solvent for the organic styrene resin pigment, whereby when said writing liquid is applied to said opaque layer according to a pattern of information the opaque layer becomes transparent to visible light according to said pattern.

WO 81/01389A1 discloses a self-supporting microvoid-containing sheet material which is substantially insensitive to marking by the localized application of heat or pressure but which is receptive to ink, pencil, crayon or similar markings and which is adapted to being temporarily or permanently provided with markings by the application of a colorless liquid, comprising in combination: a self-supporting base sheet and, bonded over at least one side of said base sheet, a reflective opaque white to pastel layer comprising particles bonded by a binder, said particles and binder both having a refractive index in the range of 1.3 to 2.2, interconnected microvoids being present throughout said layer, characterized in that the binder:particle volume ratio being in the range of about 1:20 to 2:3, so that the particles are held in pseudo-sintered juxtaposition, the void volume of the layer being in the range of 15-70%, said binder being thermoset, and layer having an image force of at least 200 grams-force.

U.S. Pat. No. 4,499,211 discloses a microporous molded article having an open-cell structure and comprising a thermoplastic material which possesses an inherent latent structural convertibility and includes effective pores of a diameter in the range from about 0.002 to 10 μm, said thermoplastic material comprising at least about 70 percent by weight of a terpolymer which is composed of from about 20 to 80 percent by weight, relative to the total weight of the terpolymer, of copolymerized fluorinated olefin selected from the group consisting of ethylene and propylene, up to about 40 percent by weight, relative to the total weight of the terpolymer, of copolymerized olefin selected from the group consisting of ethylene and propylene, and from about 80 to 20 percent by weight, relative to the total weight of the copolymer, of copolymerized vinyl acetate, with at least 5 percent of the total proportion of acetate groups contained in the copolymer being converted by saponification into OH groups after copolymerization of the specified comonomers to form the terpolymer.

EP-A 0 390 638 discloses a base sheet comprising a layer capable of becoming, in reversible manner, transparent by contact with a liquid, resistant to a marking by localized application of pressure and/or heat, characterized by the fact that it comprises: at least one flexible sheet, at least one layer applied in aqueous form on the flexible sheet and then dried, said sheet being microporous, opaque, and containing at least non-thermoset particles, at least one binder and optionally other additives.

JP 10-157280A discloses a recording material capable of being printed repeatedly by ink jet printing without deteriorating its recording performance even in the case of using many times by incorporating mat or porous surface and a solvent receiving layer which becomes opaque when no solvent exists and transparent when solvent is received.

U.S. Pat. No. 6,364,993 discloses a laminate comprising a substrate having a first substrate surface containing an image thereon and a polymeric film laminated to said first substrate surface overlying said image, said film containing an exposed water activatable opaque layer having a thickness ranging from about 0.6 mil to about 2.0 mil, said opaque layer derived from a coating formulation comprising from about 5 to about 40 wt. % aluminum silicate and from about 60 to about 95 wt. % binder, wherein the binder comprises a mixture of solvent, butyl acetate, ethylene glycol monobutyl ether and propylene glycol.

U.S. Pat. No. 6,723,383 discloses a process for producing a dry image comprising the steps of: (a) applying an opaque coating composition to the surface of a substrate to form an opaque coating on the substrate, wherein the surface is selected from the group consisting of a light-emitting surface, a reflective surface, a glossy surface, a luminescent surface, and a combination thereof; and (b) contacting the coated substrate with a recording liquid, wherein the opaque coating composition includes an opaque coating agent comprising a polymeric polyacid and a polymeric polybase, and wherein the opaque coating contacted with the recording liquid becomes transparent as a result of the contact.

WO 04/052655A1 discloses a multi-layer opaque and matte ink-jet recording medium, suitable for recording images with dye and pigmented inks, which goes through phase change from opaque to transparent and glossy in at least one printed area to reveal the surface of a substrate and thereby provide light-emitting, glossy, reflective, metallic-looking images or to show holographic images, wherein the recording medium comprises a substrate coated with at least two chemically coupled layers comprising: (a) a first transparent ink-receptive layer comprising a polymeric binder and a cross-linker and optionally having a plasticizer and pigment particles such as alumina and silica coated over the substrate, wherein the cross-linker comprises an azetidinium polymer or a salt thereof, and/or a polyfunctional aziridine or a salt thereof, or a polyfunctional oxazoline and metallic salts; and (b) a second ink-receptive layer comprising an opaque or semi-opaque coating composition, wherein the opaque or semi-opaque coating composition is capable of accepting a printed image and thereby becoming semitransparent or clearly transparent from application of ink-jet printing ink or similar inks, while presenting a light-emitting, reflective, glossy, metallic-looking or holographic or transparent image of high clarity and quality, wherein said first layer is located between said second layer and the substrate in said recording medium and the first and second layer are chemically coupled.

The inventions of EP-A 1 362 710 and EP-A 1 398 175 both disclose a porous opaque ink receiving layer comprising a pigment and a binder, which is capable of being transparentized with a UV-curable lacquer. There is a need to extend the security possibilities for providing additional security features to the information carriers disclosed in EP-A 1 362 710 and EP-A 1 398 175. There is also the need for the possibility of personalizing the information carrier i.e. incorporating personal details of the information card carrier e.g. an image or other identification. In particular, it has hitherto not been possible to combine coloured ink-jet printed images, patterns and information in a secure way with the classical black characters IR-printed in polycarbonate-based information carriers in the personalization process.

### ASPECTS OF THE INVENTION

It is an aspect of the present invention to provide information carriers with transparentizable opaque porous layers with additional security features.

It is a further aspect of the present invention to provide information carriers with transparentizable opaque porous layers with a combination of security features.

It is also an aspect of the present invention to provide information carriers with transparentizable opaque porous layers, which are capable of being individualized by the incorporation of details of the person or object associated with the information carrier.

Further aspects and advantages of the present invention will become apparent from the description hereinafter.

### SUMMARY OF THE INVENTION

Surprisingly it has been found that printing of a coloured pattern including black if black is produced by a combination of colours on a receiving layer configuration comprising a binder and a pigment, the receiving layer configuration being opaque and porous and capable of being transparentized by penetration by a curable lacquer, has after transparentization no substantial effect on heat mode writing or photo-mode writing in a layer or element below the outermost surface of the receiving layer configuration with the outermost layer of the receiving layer configuration being uppermost. This enables personalization of an information carrier precursor with as a result a combination of a coloured or monochrome image provided in or on the information carrier precursor by non-impact and/or impact printing e.g. diffusion transfer reversal processes with heat-mode or photo-mode writing in one and the same information carrier. Moreover, the type of image, i.e. continuous or half-tone, and the resolution thereof can be changed by varying the composition of the receiving layer configuration.

Aspects of the present invention are realized by a method for producing an information carrier comprising the steps of: (1) providing an information carrier precursor comprising: a rigid sheet or support; a receiving layer configuration comprising at least one constituent layer; and a layer or element capable of a human-readable or machine-readable change upon absorbing UV, visible or IR radiation, wherein at least one layer of the receiving layer configuration is opaque, porous, has the capability of being rendered substantially transparent upon penetration by a lacquer provided at the outermost surface of the receiving layer configuration and comprises at least one pigment and at least one binder; (2) realizing a temporary transparentization pattern by applying a vaporizable liquid pattern-wise or integrally to the receiving layer configuration; (3) writing with a light source a first pattern in the layer or element capable of human readable or machine-readable change; and in any order evaporating the vaporizable liquid; applying a second pattern to the outermost layer of the receiving layer configuration; and realizing a permanent transparentization pattern by applying a lacquer pattern-wise or integrally to the receiving layer configuration; with the proviso that the lacquer is applied after the vaporizable liquid has been evaporated, thereby producing an information carrier.

Aspects of the present invention are also realized by a method for producing an information carrier comprising the steps of: (1) providing an information carrier precursor comprising: a rigid sheet or support; a receiving layer configuration comprising at least one constituent layer; and a layer or element capable of a human-readable or machine-readable change upon absorbing UV, visible or IR radiation, wherein at least one layer of the receiving layer configuration is opaque, porous, has the capability of being rendered substantially transparent upon penetration by a lacquer provided at the outermost surface of the receiving layer configuration and comprises at least one pigment and at least one binder; and in any order applying a third pattern to the outermost layer of the receiving layer configuration; realizing a permanent transparentization pattern by applying a lacquer pattern-wise or integrally to the receiving layer configuration; and writing with a light source a fourth pattern in the layer or element capable of human readable or machine-readable change upon absorbing UV, visible or IR radiation after transmission through at least part of the transparentized areas of the receiving layer configuration, with the proviso that the transparentization process is carried out prior to the writing step, thereby producing an information carrier.

Further aspects of the present invention are disclosed in the dependent claims.

### DETAILED DESCRIPTION

### Definitions

The term “information carrier precursor”, as used in disclosing the present invention, means an intermediate product used in the realization of information carriers.

The term “receiving layer”, as used in disclosing the present invention, means having the ability to receive ink-jet ink with rapid drying i.e. having sufficient porosity to wick away rapidly the ink-jet ink dispersion medium.

The term “porous layer”, as used in disclosing the present invention, means a layer with pores, which can be in the ingredients of the layer and/or in addition to the ingredients of the layer e.g. a layer containing a porous ingredient is a porous layer.

The term “diffusion inhibitor”, as used in disclosing the present invention, means a substance which inhibits the transparentization of and hinders the diffusion of substances into opaque porous layers comprising at least one pigment and at least one binder and capable of transparentization with a lacquer, the substance being preferably a non-polymeric compound.

The terms “opaque” and “non-transparent” layer, as used in disclosing the present invention, refer to a layer which is non-transparent. The term “white non-transparent film”, as used in disclosing the present invention, means a white film capable of providing sufficient contrast to a transparent image to make the image clearly perceptible. A white non-transparent film can be an “opaque film”, but need not necessarily be completely opaque in that there is no residual translucence i.e. no light penetration through the film. Optical density in transmission as measured with a MacBeth TR924 densitometer through a visible filter can provide a measure of the non-transparency of a film. ISO 2471 concerns the opacity of paper backing and is applicable when that property of a paper is involved that governs the extent to which one sheet visually obscures printed matter on underlying sheets of similar paper and defines opacity as “the ratio, expressed as a percentage, of the luminous reflectance factor of a single sheet of the paper with a black backing to the intrinsic luminous reflectance factor of the same sample with a white reflecting backing. 80 g/m² copy paper, for example, is white, non-transparent and has an optical density of 0.5 as measured with a MacBeth TR924 densitometer through a yellow filter according to ISO 5-2 and metallized films typically have an optical density ranging from 2.0 to 3.0. The opaque porous layers, used in the present invention, have very high haze values e.g. 98% indicating very high light scattering. A relative opacity can be defined by assigning a 100% opacity to the initial optical density measured under standard conditions with a black background, D_{ref}, and assigning a 0% opacity to complete transparentization under standard conditions with a black background, D_{black}, i.e. an optical density corresponding to a combination of the black background and the optical density of the support. The percentage opacity is then given by the expression: (D_{black}−D_{observed})/(D_{black}−D_{ref})

The term “substantially transparent”, as used in disclosing the present invention, means having the property of transmitting at least 75% of the incident visible light without substantially diffusing it.

The term “transparentizing lacquer”, as used in disclosing the present invention, means a liquid under the application conditions, which is transparent, comprises at least one polymer and/or at least one wax and/or at least one polymerizable substance (e.g. monomers and oligomers) and can solidify upon cooling, become solid upon evaporation of solvent or harden/cross-link upon exposure to heat, moisture or radiation, e.g. visible light, UV-radiation and electron beams i.e. is curable, which transparentizes the receiving layer configuration.

The term “non-transparentizing lacquer”, as used in disclosing the present invention, means a liquid under the application conditions, which comprises at least one polymer and/or at least one wax and/or at least one polymerizable substance (e.g. monomers and oligomers) and can solidify upon cooling, become solid upon evaporation of solvent or harden/cross-link upon exposure to moisture or radiation e.g. visible light, UV-radiation and electron beams i.e. is curable, which does not transparentize the receiving layer configuration.

The term “capability of being rendered substantially transparent by a lacquer”, as used in disclosing the present invention, means that the receiving layer configuration at least becomes transparent upon penetration of the lacquer. This does not exclude the realization of transparency with a liquid if the refractive index of the liquid is similar to that of the pigment in the at least one opaque, porous layer. Such a liquid e.g. water or a solvent, will provide transparentization for as long as the liquid remains in the pores i.e. provides a temporary transparentization.

The term “mordant”, as used in disclosing the present invention, means a substance capable of binding or fixing i.e. providing preferential adsorption for at least one functional species.

The term “functional species”, as used in disclosing the present invention, means a species having functional properties such that it can be detected either visually with or without assistance of an appropriate light source or with detection apparatus i.e. is human or machine readable. Such functional species can, for example, be used in realizing a security feature. Examples of such functional species are infrared-absorbing species, metals, luminescing organic or organometallic species and dyes. The dyes can, for example, provide an image of a person to whom the information carrier belongs or has been assigned or other image as required.

The terms “on”, “onto” and “in”, as used in disclosing the present invention, have very precise meanings with respect to a layer: “on” means that penetration of the layer may or may not occur, “onto” means at least 90% on the top of i.e. there is no substantial penetration into the layer, and “in” means that penetration into the respective layer or layers occurs. With printing digitally stored information “onto” a porous receiving layer configuration, we understand that an image is provided “on and/or in” the receiving layer configuration. In the case of ink jet printing, if the ink remains on top of the receiving layer configuration, the image is provided “onto” the receiving layer, which, for example, may be the case if pigment-based ink-jet inks are used. If the ink penetrates into the porous receiving layer configuration, it is “in” the layer.

The term “conventional printing process”, as used in disclosing the present invention refers to impact printing processes as well as to non-impact printing processes applied both to the printing of graphics and to the printing of functional patterns e.g. a conductive pattern. The term includes but is not restricted to ink-jet printing, intaglio printing, screen printing, flexographic printing, driographic printing, electrophotographic printing, electrographic printing, offset printing, stamp printing, gravure printing, thermal and laser-induced processes and also includes diffusion transfer processes and a printing process rendering areas of a conductive layer non-conductive in a single pass process, such as disclosed in EP 1 054 414A and WO 03/025953A, but excludes processes such as evaporation, etching, diffusion processes used in the production of conventional electronics e.g. silicon-based electronics.

The term “impact printing process”, as used in disclosing the present invention, means a printing process in which contact is made between the medium in which the print is produced and the printing system e.g. printers that work by striking an ink ribbon such as daisy-wheel, dot-matrix and line printers, diffusion transfer processes (e.g. COPYCOLOR® materials from AGFA-GEVAERT) and direct thermal printers in which the thermographic material is printed by direct contact with heating elements in a thermal head and printers in which a master is covered with an ink layer on areas corresponding to a desired image or shape, after which the ink is transferred to the medium, such as offset, gravure or flexographic printing.

The term “non-impact printing process”, as used in disclosing the present invention, means a printing process in which no contact is made between the medium in which the print is produced and the printing system e.g. electrographic printers, electrophotographic printers, laser printers, ink jet printers in which prints are produced without needing to strike the print medium.

The term “pattern”, as used in disclosing the present invention, includes holograms, images, representations, guilloches, graphics and regular and irregular arrays of symbols, images, geometric shapes and non-geometric shapes and can consist of pixels, continuous tone, lines, geometric shapes and/or any random configuration.

The term “pattern-wise”, as used in disclosing the present invention, means as a pattern and embraces the term image-wise.

The term “coloured image”, as used in disclosing the present invention, is an image produced with one or more colorants and which in the case of the colour black is produced by a combination of at least two colorants.

The term “colorant”, as used in disclosing the present invention, means a substance absorbing in the visible spectrum between 400 nm and 700 nm.

The term “dye”, as used in disclosing the present invention, means a colouring agent having a solubility≧10 mg/L in the medium in which it is applied and under the ambient conditions pertaining.

The term “pigment”, as used in disclosing the present invention, is defined in DIN 55943, herein incorporated by reference, as an inorganic or organic, chromatic or achromatic colouring agent that is practically insoluble in the application medium under the pertaining ambient conditions, hence having a solubility of less than 10 mg/L therein.

The term “security print”, as used in disclosing the present invention, means a printed pattern designed to be difficult to counterfeit and hence providing a security feature.

The term “layer”, as used in disclosing the present invention, means a coating covering the whole area of the entity referred to e.g. a support.

The term “discontinuous layer”, as used in disclosing the present invention, means a coating not covering the whole area of the entity referred to e.g. a support.

PET is an abbreviation for polyethylene terephthalate.

PETG is an abbreviation for polyethylene terephthalate glycol, the glycol indicating glycol modifiers i.e. partial replacement of ethylene glycol by alternative glycols such as 1,4-cyclohexanedimethanol or neopentyl glycol which minimize brittleness and premature aging that occur if unmodified amorphous polyethylene terephthalate (APET) is used in the production of cards.

### Method for Producing an Information Carrier

Aspects of the present invention are realized by a method for producing an information carrier comprising the steps of: (1) providing an information carrier precursor comprising: a rigid sheet or support; a receiving layer configuration comprising at least one constituent layer; and a layer or element capable of a human-readable or machine-readable change upon absorbing UV, visible or IR radiation, wherein at least one layer of the receiving layer configuration is opaque, porous, has the capability of being rendered substantially transparent upon penetration by a lacquer provided at the outermost surface of the receiving layer configuration and comprises at least one pigment and at least one binder; (2) realizing a temporary transparentization pattern by applying a vaporizable liquid pattern-wise or integrally to the receiving layer configuration; (3) writing with a light source a first pattern in the layer or element capable of human readable or machine-readable change; and in any order evaporating the vaporizable liquid; applying a second pattern to the outermost layer of the receiving layer configuration; and realizing a permanent transparentization pattern by applying a lacquer pattern-wise or integrally to the receiving layer configuration; with the proviso that the lacquer is applied after the vaporizable liquid has been evaporated, thereby producing an information carrier.

Vaporizable transparentizing liquids include water, organic solvents, mixtures of water with organic solvents and solvent mixtures. Selection is dependent upon the refractive index of the liquid, its ease of evaporation, its viscosity and its ability to wet the pores in the receiving layer configuration and therefore enable penetration of the receiving layer configuration. If the pores have a hydrophilic character, hydrophilic liquids with the requisite refractive index will be required and if the pores have a hydrophobic character, hydrophobic liquids with the requisite refractive index will be required. The refractive index should differ from that of the pigment used in the receiving layer configuration by no more than 0.1, with a difference of 0.04 being preferred and a difference of 0.02 being particularly prepared.

If porous silica e.g. silica gel is used as a pigment in the receiving layer configuration, the following vaporizable liquids are suitable for obtaining temporary transparentization:

| | Boiling point | Refractive index at 20° C. |
|---|---|---|
| | [° C.] | with sodium line at 589.3 nm |
| 2-butanol | 99.5 | 1.397 |
| n-butyl acetate | 126.1 | 1.394 |
| chloroform | 61.2 | 1.4458 |
| cyclohexane | 80.7 | 1.426 |
| cyclopentane | 49.3 | 1.406 |
| dichloromethane | 39.8 | 1.4241 |
| 1,4-dioxane | 101 | 1.4224 |
| ethylene glycol | 198.9 | 1.4318 |
| methylethylketone | 79.6 | 1.379 |
| N-methyl-2-pyrrolidone | 202.0 | 1.488 |
| heptane | 98.4 | 1.3878 |
| Isobutyl alcohol | 107.9 | 1.396 |
| octane | 125.7 | 1.3974 |
| tetrachloroethylene | 121.2 | 1.506 |
| tetrahydrofuran | 66 | 1.4072 |
| toluene | 110.6 | 1.497 |
| trichloroethylene | 87 | 1.4767 |
| 2,2,4-trimethylpentane | 99.2 | 1.391 |

Aspects of the present invention are also realized by a method for producing an information carrier comprising the steps of: (1) providing an information carrier precursor comprising: a rigid sheet or support; a receiving layer configuration comprising at least one constituent layer; and a layer or element capable of a human-readable or machine-readable change upon absorbing UV, visible or IR radiation, wherein at least one layer of the receiving layer configuration is opaque, porous, has the capability of being rendered substantially transparent upon penetration by a lacquer provided at the outermost surface of the receiving layer configuration and comprises at least one pigment and at least one binder; and in any order applying a third pattern to the outermost layer of the receiving layer configuration; realizing a permanent transparentization pattern by applying a lacquer pattern-wise or integrally to the receiving layer configuration; and writing with a light source a fourth pattern in the layer or element capable of human readable or machine-readable change upon absorbing UV, visible or IR radiation after transmission through at least part of the transparentized areas of the receiving layer configuration, with the proviso that the transparentization process is carried out prior to the writing step, thereby producing an information carrier.

Complete penetration of the receiving layer configuration with the lacquer results in substantial transparentization of the porous, opaque receiving layer configuration. Less than complete i.e. partial penetration of the porous, opaque receiving layer configuration with the lacquer results in partial transparentization i.e. an increased transparency over a non-transparentized porous, opaque receiving layer configuration, but less transparency than that obtaining upon complete transparentization of the porous, opaque receiving layer configuration.

Transparentization can be realized temporarily with a vaporizable liquid or permanently with a transparentizing lacquer. If pattern-wise or integral temporary transparentization is initially used followed by permanent transparentization, the possibility arises of the realization of a first or fourth pattern by light source writing during temporary transparentization, which is not wholly visible if the permanent transparentization is carried out pattern-wise. This is an added security feature.

According to a first embodiment of the method for producing an information carrier, according to the present invention, any of the patterns is a coloured pattern e.g. monochrome or multicoloured.

According to a second embodiment of the method for producing an information carrier, according to the present invention, the light source is a laser.

According to a third embodiment of the method for producing an information carrier, according to the present invention, the human-readable change is a density or colour change.

According to a fourth embodiment of the method for producing an information carrier, according to the present invention, the machine-readable change is a change in light emission properties, in a conductive pattern, in an inductively readable pattern, in an electrical circuit or in a RF-readable entity.

According to a fifth embodiment of the method for producing an information carrier, according to the present invention, the information carrier precursor further comprises an opaque element between the side of the receiving layer configuration nearer the support and the support.

According to a sixth embodiment of the method for producing an information carrier, according to the present invention, the second or third pattern is applied using a conventional printing technique, with non-impact printing or impact printing being preferred and ink-jet printing being particularly preferred. The non-impact printing technique used for applying the second or third pattern is preferably selected from the group consisting of electrophotographic printing, electrophoretic printing and ink-jet printing. The impact printing technique used for applying the second or third pattern is preferably selected from the group consisting of thermal dye transfer printing, screen printing, offset printing, gravure printing and flexographic printing.

According to a seventh embodiment of the method for producing an information carrier, according to the present invention, pattern-wise transparentization is followed by applying a second or third pattern using a conventional printing process only to the opaque, porous parts of the outermost surface of the receiving layer configuration corresponding to the opaque, porous parts of said at least one opaque, porous layer remaining after pattern-wise transparentization, the conventional printing technique being preferably a non-impact or an impact technique with ink-jet printing being particularly preferred.

According to an eighth embodiment of the method for producing an information carrier, according to the present invention, the method of applying a second or third pattern to the outermost surface of the receiving layer configuration is a non-impact printing technique selected from the group consisting of electrophotographic printing, electrophoretic printing and ink-jet printing.

According to a ninth embodiment of the method for producing an information carrier, according to the present invention, the method of applying a coloured second or third pattern to the outermost surface of the receiving layer configuration is an impact printing technique selected from the group consisting of thermal dye sublimation printing, thermal dye transfer printing, screen printing, offset printing, gravure printing, flexographic printing and diffusion transfer reversal processes.

According to a tenth embodiment of the method for producing an information carrier, according to the present invention, the penetrating transparentizing lacquer further comprises a functional ingredient such as a fluorescent or phosphorescent compound, a fluorescent or phosphorescent fibre, a heat-mode sensitive ingredient, and a compound or compound mixture with a characteristic smell, such as a perfume or scent.

According to an eleventh embodiment of the method for producing an information carrier, according to the present invention, a hologram is written on or applied to the surface of the rigid sheet or support and/or to the surface of any layer comprised in the information carrier e.g. the outermost surface of the information carrier.

According to a twelfth embodiment of the method for producing an information carrier, according to the present invention, an embossable layer is applied to the surface of the rigid sheet or support and/or to the surface of any layer comprised in the information carrier e.g. the outermost surface of the information carrier and the embossable layer is then embossed e.g. as a hologram.

According to a thirteenth embodiment of the method for producing an information carrier, according to the present invention, a black image is printed on the outermost surface of the information carrier and the black image develops a relief pattern upon UV-irradiation.

According to a fourteenth embodiment of the method for producing an information carrier, according to the present invention, a metal fibre or strip is applied to the outermost surface of the information carrier in a hardenable composition.

According to a fifteenth embodiment of the method for producing an information carrier, according to the present invention, in the event of pattern-wise transparentization of the receiving layer configuration, the non-transparentized areas of the receiving layer configuration are penetrated with a non-transparentizing lacquer.

According to a sixteenth embodiment of the method for producing an information carrier, according to the present invention, in the event of pattern-wise non-transparentization of the receiving layer configuration, the transparentizable areas of the receiving layer configuration are penetrated with a transparentizing lacquer.

When the information carrier is meant to be cut later on in multiple identity cards the security print is repeatedly applied over multiple areas of the web or sheet by a step and repeat process thus giving rise to multiple identical items. These multiple identical items are distributed over the support according to a fixed pattern, e.g. a rectangular grid.

According to a seventeenth embodiment of the method for producing an information carrier, according to the present invention, the second or third pattern applied to the outermost layer of the receiving layer configuration is a digitally stored set of information, applied, for example, by means of ink jet printing or thermal dye transfer printing. Printing techniques using toner particles can however also be used with the restriction that toner particles containing carbon black are not transparent to IR, visible and UV radiation. However, a pattern non-transparent to IR, visible and UV radiation provides an additional security feature.

According to an eighteenth embodiment of the method for producing an information carrier, according to the present invention, the second or third pattern applied to the outermost layer of the receiving layer configuration is a digitally stored set of information, which is personalized information different for each individual item present on the information carrier. For instance, this personalized information may be a unique individual card number assigned to the future bearer of the card and/or the expiry date of the validity of the card and/or personal data of the future bearer, e.g. a birth day and/or a photo. Again, when the information carrier is meant to be cut in multiple ID cards, the ink jet printing step is repeated over multiple areas of the support in register with the security print pattern when present, thereby providing each item with different personalized information.

When the information carrier is meant to be cut in multiple ID cards, the application and curing of the varnish is repeated over multiple areas of the information carrier fully or partially in register with the multiple different items already present consisting of optional security print and personalized information.

According to a nineteenth embodiment of the method for producing an information carrier, according to the present invention, the pattern-wise or integrally at least partially transparentization of the receiving layer configuration is carried out by coating, printing, spraying or jetting a lacquer composition on the outermost surface of the receiving layer configuration, with the lacquer preferably being curable and particularly preferably being thermally or radiation curable e.g. UV-curable or electron beam curable. In the case of pattern-wise at least partial transparentization, the at least partial transparentization is preferably carried out by ink-jet printing. As explained above the better the match of the refraction indices of the lacquer composition and the pigment in the receiver layer the better the transparency.

Apparatuses for UV-curing are known to those skilled in the art and are commercially available. For example, UV-curing can be carried out with medium pressure mercury vapour lamps with or without electrodes, or pulsed xenon lamps. These ultraviolet light sources are usually equipped with a cooling installation, an installation to remove the ozone produced and optionally a nitrogen inflow to exclude air from the surface of the product to be cured during radiation processing. An intensity of 40 to 240 W/cm in the 200-400 nm spectral region is usually employed. An example of a commercially available UV-curing unit is the DRSE-120 conveyor from Fusion UV Systems Ltd., UK with a VPS/1600 UV lamp, an ultraviolet medium-pressure electrodeless mercury vapour lamp. The DRSE-120 conveyor can operate at different transport speeds and different UV power settings over a width of 20 cm and a length in the transport direction of 0.8 cm. Moreover, it can also be used with metal halide-doped Hg vapour or XeCl excimer lamps, each with its specific UV emission spectrum. This permits a higher degree of freedom in formulating the curing composition: a more efficient curing is possible using the lamp with the most appropriate spectral characteristics. A pulsed xenon flash lamp is commercially available from IST Strahlentechnik GmbH, Nürtingen, Germany.

As a result of the curing the cohesive force of the receiving layer configuration and the adhesive force between the receiver and the support are strongly improved rendering in this way the information carrier tamper proof since it has become strongly resistant to mechanical and chemical influences.

### Ink-Jet Printing and Ink-Jet Inks

If ink jet printing is used in the method for producing an information carrier, according to the present invention, it may be performed by any known technique known in the art. In a first type of process a continuous droplet stream is created by applying a pressure wave pattern. This process is known as continuous ink jet printing. In a first embodiment the droplet stream is divided into droplets that are electrostatically charged, deflected and recollected, and into droplets that remain uncharged, continue their way undeflected, and form the image. Alternatively, the charged deflected stream forms the image and the uncharged undeflected jet is recollected. In this variant of continuous ink jet printing several jets are deflected to a different degree and thus record the image (multideflection system).

According to a second ink-jet process the ink droplets can be created “on demand” (“DOD” or “drop on demand” method) whereby the printing device ejects the droplets only when they are used in imaging on a receiver thereby avoiding the complexity of drop charging, deflection hardware, and ink recollection. In drop-on-demand the ink droplet can be formed by means of a pressure wave created by a mechanical motion of a piezoelectric transducer (so-called “piezo method”), or by means of discrete thermal pushes (so-called “bubble jet” method, or “thermal jet” method).

Ink compositions for ink jet typically include following ingredients: dyes or pigments, water and/or organic solvents, humectants such as glycols, detergents, thickeners, polymeric binders, preservatives, etc. It will be readily understood that the optimal composition of such an ink is dependent on the ink jetting method used and on the nature of the substrate to be printed. The ink compositions can be roughly divided into:

water based: drying mechanism involves absorption, penetration and evaporation;

oil based: drying involves absorption and penetration;

solvent based: drying mechanism involves primarily evaporation;

hot melt or phase change: the ink vehicle is liquid at the ejection temperature but solid at room temperature; drying is replaced by solidification;

UV-curable: drying is replaced by photopolymerization.

### The colorants present in the ink jet ink may be dyes which are molecularly dissolved in the ink fluid, e.g. acid dyes which are bound by a cationic mordant in the ink receiver, or they may be pigments which are finely dispersed in the ink fluid.

### Information Carrier Precursor

The methods for producing an information carrier, according to the present invention, use an information carrier precursor comprising: a rigid sheet or support; a receiving layer configuration comprising at least one layer; and a layer or element capable of a human-readable or machine-readable change upon absorbing UV, visible or IR radiation, wherein at least one layer of the receiving layer configuration is opaque, porous, has the capability of being rendered substantially transparent by penetration by a lacquer provided at the outermost surface of the receiving layer configuration and comprises at least one pigment and at least one binder; and optionally an opaque element between the side of the receiving layer configuration closer to the support and the support, which may be contiguous or non-contiguous with the side of the receiving layer configuration closer to the support.

The optional opaque element non-contiguous with the receiving layer configuration may be optionally preprinted with a so-called security print. The security print may include any additional security element, for instance, a hologram, iridescence, a seal, a concrete recognizable design, or an abstract periodically repeating monochrome or multichrome pattern, or a gradually changing colour pattern, which gradually changes in hue and/or density of the colours, and is in this way difficult to counterfeit. Preferably the spectral characteristics of the inks of the security print are chosen so that they are difficult to copy by means of a commercial colour copier. This security print may further contain e.g. a logo, name or abbreviation of the issuing authority of the information carrier. This security print can be applied by any known printing technique, e.g. letterpress, intaglio printing, lithographic printing, gravure printing, silk screen printing, etc. A preferred technique is driographic printing being a waterless variant of lithographic printing whereby no fountain solution is applied to the printing press.

### Receiving Layer Configuration

The receiving layer configuration comprises a single layer or multiple layers. Only one of the constituent receiving layers of the receiving layer configuration need comprise at least one pigment, at least one binder and consists at least in part of areas which are both opaque and porous and which are transparentizable upon penetration by a lacquer. Multiple layers comprising the receiving layer configuration can be coated or printed simultaneously or sequentially and may have the same or different compositions e.g. to vary the porosity of the individual layers.

The receiving layer configuration may be coated onto the support by any conventional coating technique, such as dip coating, knife coating, extrusion coating, spin coating, slide hopper coating and curtain coating, and any conventional printing technique, such as screen printing, offset printing, ink-jet printing, gravure printing and intaglio printing.

The composition of individual layers in the receiving layer configuration can be modified after deposition by coating or printing by, for example, pattern-wise or non-pattern-wise deposition of a substance in a form which can mix with, e.g. upon partial dissolution of the uppermost part of the layer, or diffuse into layer.

The constituent receiving layers and the optional supplementary layers used in the information carrier precursor, according to the present invention, may further contain well-known conventional ingredients, such as surfactants serving as coating aids, hardening agents, plasticizers, whitening agents and matting agents.

Suitable surfactants are any of the cationic, anionic, amphoteric, and non-ionic ones as described in JP-A 62-280068 (1987). Examples of the surfactants are N-alkylamino acid salts, alkylether carboxylic acid salts, acylated peptides, alkylsulphonic acid salts, alkylbenzene and alkylnaphthalene sulphonic acid salts, sulphosuccinic acid salts, α-olefin sulphonic acid salts, N-acylsulphonic acid salts, sulphonated oils, alkylsulphonic acid salts, alkylether sulphonic acid salts, alkylallylethersulphonic acid salts, alkylamidesulphonic acid salts, alkylphosphoric acid salts, alkyletherphosphoric acid salts, alkylallyletherphosphoric acid salts, alkyl and alkylallylpolyoxy-ethylene ethers, alkyl-allylformaldehyde condensed acid salts, alkylallylethersulphonic acid salts, alkylamidesulphonic acid salts, alkylphosphoric acid salts, alkyletherphosphoric acid salts, alkylallyletherphosphoric acid salts, alkyl and alkylallylpolyoxy-ethylene ethers, alkyl-allylformaldehyde condensed polyoxyethylene ethers, blocked polymers having polyoxypropylene, polyoxyethylene polyoxypropylalkylethers, polyoxyethyleneether of glycolesters, polyoxyethyleneether of sorbitanesters, polyoxyethyleneether of sorbitolesters, polyethyleneglycol aliphatic acid esters, glycerol esters, sorbitane esters, propyleneglycol esters, sugaresters, fluoro C₂-C₁₀ alkylcarboxylic acids, disodium N-perfluorooctanesulphonyl glutamate, sodium 3-(fluoro-C₆-C₁₁-alkyloxy)-1-C₃-C₄ alkyl sulphonates, sodium 3-(ω-fluoro-C₆-C₈-alkanoyl-N-ethylamino)-1-propane sulphonates, N-[3-(perfluorooctanesulphonamide)-propyl]-N,N-dimethyl-N-carboxymethylene ammonium betaine, fluoro-C₁₁-C₂₀ alkylcarboxylic acids, perfluoro-C₇-C₁₃-alkyl-carboxylic acids, perfluorooctane sulphonic acid diethanolamide, Li, K and Na perfluoro-C₄-C₁₂-alkyl sulphonates, N-propyl-N-(2-hydroxyethyl)perfluorooctane sulphonamide, perfluoro-C₆-C₁₀-alkylsulphonamide-propyl-sulphonyl-glycinates, bis-(N-perfluorooctylsulphonyl-N-ethanolaminoethyl)phosphonate, mono-perfluoro C₆-C₁₆ alkyl-ethyl phosphonates, and perfluoroalkylbetaine.

Useful cationic surfactants include N-alkyl dimethyl ammonium chloride, palmityl trimethyl ammonium chloride, dodecyldimethyl-amine, tetradecyldimethylamine, ethoxylated alkyl guanidine-amine complex, oleamine hydroxypropyl bistrimonium chloride, oleyl imidazoline, stearyl imidazoline, cocamine acetate, palmitamine, dihydroxyethylcocamine, cocotrimonium chloride, alkyl polyglycol-ether ammonium sulphate, ethoxylated oleamine, lauryl pyridinium chloride, N-oleyl-1,3-diaminopropane, stearamidopropyl dimethylamine lactate, coconut fatty amide, oleyl hydroxyethyl imidazoline, isostearyl ethylimidonium ethosulphate, lauramidopropyl PEG-diamoniumchloride phosphate, palmityl trimethylammonium chloride, and cetyltrimethylammonium bromide.

Especially useful surfactants are the fluorocarbon surfactants having a structure of: F(CF₂)₄₋₉CH₂CH₂SCH₂CH₂N⁺R₃X⁻ wherein R is a hydrogen or an alkyl group as described in e.g. U.S. Pat. No. 4,781,985; and having a structure of: CF₃(CF₂)ₘCH₂CH₂—O—(CH₂CH₂O)ₙR wherein m=2 to 10; n=1 to 18; R is hydrogen or an alkyl group of 1 to 10 carbon atoms as described in U.S. Pat. No. 5,084,340. These surfactants are commercially available from DuPont and 3M. The concentration of the surfactant component in the receiving layer is typically in the range of 0.1 to 2%, preferably in the range of 0.4 to 1.5% and is most preferably 0.75% by weight based on the total dry weight of the layer.

Furthermore, the constituent receiving layers may be lightly crosslinked to provide such desired features as waterfastness and non-blocking characteristics. However, the degree of cross-linking should be such that neither the diffusion of the functional species or functional species precursor nor the penetration of the lacquer should be substantially affected. Crosslinking is also useful in providing abrasion resistance and resistance to the formation of fingerprints on the element as a result of handling. There are a vast number of known crosslinking agents—also known as hardening agents—that will function to crosslink film forming binders. Hardening agents can be used individually or in combination and in free or in blocked form. A great many hardeners, useful for the present invention, are known, including formaldehyde and free dialdehydes, such as succinaldehyde and glutaraldehyde, blocked dialdehydes, active esters, sulphonate esters, active halogen compounds, isocyanate or blocked isocyanates, polyfunctional isocyanates, melamine derivatives, s-triazines and diazines, epoxides, active olefins having two or more active bonds, carbodiimides, zirconium complexes, e.g. BACOTE 20, ZIRMEL 1000 or zirconium acetate, trademarks of MEL Chemicals, titanium complexes, such as TYZOR grades from DuPont, isoxazolium salts substituted in the 3-position, esters of 2-alkoxy-N-carboxy-dihydroquinoline, N-carbamoylpyridinium salts, hardeners of mixed function, such as halogen-substituted aldehyde acids (e.g. mucochloric and mucobromic acids), onium substituted acroleins and vinyl sulphones and polymeric hardeners, such as dialdehyde starches and copoly(acroleinmethacrylic acid), and oxazoline functional polymers, e.g. EPOCROS WS-500, and EPOCROS K-1000 series, and maleic anhydride copolymers, e.g. GANTREZ AN119

The constituent receiving layers and the optional supplementary layers used in the information carrier precursor, according to the present invention, may also comprise a plasticizer such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalicanhydride, urea phosphate, triphenylphosphate, glycerolmonostearate, propylene glycol monostearate, tetramethylene sulphone, n-methyl-2-pyrrolidone, n-vinyl-2-pyrrolidone.

The constituent receiving layers and the optional supplementary layers used in the information carrier precursor, according to the present invention, may also contain at least one cationic substance as a mordant. Such substances increase the capacity of the layer for fixing and holding the dye of the ink droplets. A particularly suited compound is a poly(diallyldimethylammonium chloride) or, in short, a poly(DADMAC). These compounds are commercially available from several companies, e.g. Aldrich, Nalco, CIBA, Nitto Boseki Co., Clariant, BASF and EKA Chemicals.

Other useful cationic compounds include DADMAC copolymers such as copolymers with acrylamide, e.g. NALCO® 1470 from ONDEO Nalco or PAS-J-81, trademark of Nitto Boseki Co., such as copolymers of DADMAC with acrylates, such as Nalco® 8190 from ONDEO Nalco; copolymers of DADMAC with SO₂, such as PAS-A-1 or PAS-92, trademarks of Nitto Boseki Co., copolymer of DADMAC with maleic acid, e.g. PAS-410, trademark of Nitto Boseki Co., copolymer of DADMAC with diallyl(3-chloro-2-hydroxypropyl)amine hydrochloride, e.g. PAS-880, trademark of Nitto Boseki Co., dimethylamine-epichloro-hydrine copolymers, e.g. Nalco® 7135 from ONDEO Nalco or POLYFIX® 700 from Showa High Polymer Co.; other POLYFIX grades which could be used are POLYFIX® 601, POLYFIX® 301, POLYFIX® 301A, POLYFIX® 250WS, and POLYFIX® 3000; NEOFIX® E-117 from Nicca Chemical Co., a polyoxyalkylene polyamine dicyanodiamine, and REDIFLOC® 4150 a polyamine from EKA Chemicals; MADAME (methacrylatedimethylamin-oethyl=dimethylaminoethyl methacrylate) or MADQUAT (methacryloxyethyltrimethylammonium chloride) modified polymers, e.g. ROHAGIT® KL280, ROHAGIT® 210, ROHAGIT® SL144, PLEX® 4739L, PLEX® 3073 from Röhm, DIAFLOC KP155 and other DIAFLOC products from Diafloc Co., and BMB 1305 and other BMB products from EKA chemicals; cationic epichlorohydrin adducts such as POLYCUP® 171 and POLYCUP® 172 from Hercules Co.; from Cytec industries: CYPRO products, e.g. CYPRO 514/515/516, SUPERFLOC 507/521/567; cationic acrylic polymers, such as ALCOSTAT 567, trademark of CIBA, cationic cellulose derivatives such as CELQUAT® L-200, H-100, SC-240C, SC-230M from Starch & Chemical Co., and QUATRISOFT LM200, UCARE polymers JR125, JR400, LR400, JR30M, LR30M and UCARE polymer LK; fixing agents from Chukyo Europe: PALSET JK-512, PALSET JK512L, PALSET JK-182, PALSET JK-220, WSC-173, WSC-173L, PALSET JK-320, PALSET JK-320L and PALSET JK-350; polyethyleneimine and copolymers, e.g. LUPASOL® from BASF AG; triethanolamine-titanium-chelate, e.g. TYZOR® from Du Pont Co.; copolymers of vinylpyrrolidone such as VIVIPRINT® 111 from ISP, a methacrylamido propyl dimethylamine copolymer; with dimethylaminoethylmethacrylate such as COPOLYMER 845 and COPOLYMER 937, trade names of ISP; with vinylimidazole, e.g. LUVIQUAT CARE, LUVITEC 73W, LUVITEC VPI55 K18P, LUVITEC VP155 K72W, LUVIQUAT FC905, LUVIQUAT FC550, LUVIQUAT HM522, and SOKALAN HP56, all trade names of BASF AG; polyamidoamines, e.g. RETAMINOL® and NADAVIN® from Bayer AG; phosphonium compounds such as disclosed in EP 609930 and other cationic polymers such as NEOFIX® RD-5 from NICCA Chemical Co.

The constituent receiving layers and the optional supplementary layers used in the information carrier precursor, according to the present invention, may also comprise ingredients to improve the lightfastness of the printed image, such as antioxidants, UV-absorbers, peroxide scavengers, singlet oxygen quenchers such as hindered amine light stabilizers, (HALS compounds). Stilbene compounds are a preferred type of UV-absorber.

### Receiving Layer Pigment

The receiving layer pigment may be chosen from the inorganic pigments well-known in the art such as silica, talc, clay, hydrotalcite, kaolin, diatomaceous earth, calcium carbonate, magnesium carbonate, basic magnesium carbonate, aluminosilicate, aluminum trihydroxide, aluminum oxide (alumina), titanium oxide, zinc oxide, barium sulphate, calcium sulphate, zinc sulphide, satin white, boehmite (alumina hydrate), zirconium oxide or mixed oxides. In a preferred embodiment the main pigment is chosen from silica, aluminosilicate, alumina, calcium carbonate, alumina hydrate, and aluminium trihydroxide.

According to a twentieth embodiment of the method for producing an information carrier, according to the present invention, the pigment is an inorganic pigment.

According to a twenty-first embodiment of the method for producing an information carrier, according to the present invention, the pigment is silica.

Refractive indices of these pigments are given in the table below:

| | refractive index for |
|---|---|
| inorganic opacifying pigment | sodium line at 589.3 nm |
| silica—silica gel | 1.47 to 1.55 |
| kaolinite | 1.53-1.57 |
| bentonite | 1.557 |
| china clay | 1.56 |
| porous alumina pigment e.g. MARTINOX | 1.6 |
| GL-1 | |

The use of aluminium oxide (alumina) in receiving layers is disclosed in several patents, e.g. in U.S. Pat. No. 5,041,328, U.S. Pat. No. 5,182,175, U.S. Pat. No. 5,266,383, EP 218956, EP 835762 and EP 972650.

Commercially available types of aluminium oxide (alumina) include α-Al₂O₃ types, such as NORTON E700, available from Saint-Gobain Ceramics & Plastics, Inc, γ-Al₂O₃ types, such as ALUMINUM OXID C from Degussa, Other Aluminium oxide grades, such as BAIKALOX CR15 and CR30 from Baikowski Chemie; DURALOX grades and MEDIALOX grades from Baikowski Chemie, BAIKALOX CR80, CR140, CR125, B105CR from Baikowski Chemie; CAB-O-SPERSE PG003 trademark from Cabot, CATALOX GRADES and CATAPAL GRADES from Sasol, such as PLURALOX HP14/150; colloidal Al₂O₃ types, such as ALUMINASOL 100; ALUMINASOL 200, ALUMINASOL 220, ALUMINASOL 300, and ALUMINASOL 520 trademarks from Nissan Chemical Industries or NALCO 8676 trademark from ONDEO Nalco.

A useful type of alumina hydrate is γ-AlO(OH), also called boehmite, such as, in powder form, DISPERAL, DISPERAL HP14 and DISPERAL 40 from SASOL, MARTOXIN VPP2000-2 and GL-3 from Martinswerk GmbH.; liquid boehmite alumina systems, e.g. DISPAL 23N4-20, DISPAL 14N-25, DISPERAL AL25 from SASOL. Patents on alumina hydrate include EP 500021, EP 634286, U.S. Pat. No. 5,624,428, EP 742108, U.S. Pat. No. 6,238,047, EP 622244, EP 810101, etc.

Useful aluminum trihydroxides include Bayerite, or α-Al(OH)₃, such as PLURAL BT, available from SASOL, and Gibbsite, or γ-Al(OH)₃, such as MARTINAL grades from Martinswerk GmbH, MARTIFIN grades, such as MARTIFIN OL104, MARTIFIN OL 107 and MARTIFIN OL111 from Martinswerk GmbH, MICRAL grades, such as MICRAL 1440, MICRAL 1500; MICRAL 632; MICRAL 855; MICRAL 916; MICRAL 932; MICRAL 932CM; MICRAL 9400 from JM Huber company; HIGILITE grades, e.g. HIGILITE H42 or HIGILITE H43M from Showa Denka K.K., HYDRAL GRADES such as HYDRAL COAT 2, HYDRAL COAT 5 and HYDRAL COAT 7, HYDRAL 710 and HYDRAL PGA, from Alcoa Industrial Chemicals.

A useful type of zirconium oxide is NALCO OOSS008 trademark of ONDEO Nalco, acetate stabilized ZrO2, ZR20/20, ZR50/20, ZR100/20 and ZRYS4 trademarks from Nyacol Nano Technologies. Useful mixed oxides are SIRAL grades from SASOL, colloidal metaloxides from Nalco such as Nalco 1056, Nalco TX10496, Nalco TX11678.

Silica as pigment in receiving elements is disclosed in numerous old and recent patents, e.g. U.S. Pat. No. 4,892,591, U.S. Pat. No. 4,902,568, EP 373573, EP 423829, EP 487350, EP 493100, EP 514633, etc. Different types of silica may be used, such as crystalline silica, amorphous silica, precipitated silica, gel silica, fumed silica, spherical and non-spherical silica, calcium carbonate compounded silica such as disclosed in U.S. Pat. No. 5,281,467, and silica with internal porosity such as disclosed in WO 00/02734. The use of calcium carbonate in receiving layers is described in e.g. DE 2925769 and U.S. Pat. No. 5,185,213. The use of alumino-silicate is disclosed in e.g. DE 2925769. Mixtures of different pigments may be used.

In an alternative embodiment the main pigment can be chosen from organic particles such as polystyrene, polymethylmethacrylate, silicones, melamine-formaldehyde condensation polymers, urea-formaldehyde condensation polymers, polyesters and polyamides. Mixtures of inorganic and organic pigments can be used. However, most preferably the pigment is an inorganic pigment.

The pigment must be present in a sufficient coverage in order to render the receiving layer sufficiently opaque and porous. The lower limit of the ratio by weight of the binder to the total pigment in the receiving layer is preferably about 1:50, most preferably 1:20, while the upper limit thereof is about 2:1, most preferably 1:1. If the amount of the pigment exceeds the upper limit, the strength of the receiving layer itself is lowered, and the resulting image hence tends to deteriorate in rub-off resistance and the like. On the other hand, if the binder to pigment ratio is too great, the ink-absorbing capacity of the resulting receiving layer is reduced, and so the image formed may possibly deteriorate.

The transparentization process is dependent upon the refraction indices of the pigment on the one hand, and of the lacquer which penetrates the receiving layer configuration (see description below) on the other hand should match each other as closely as possible. The closer the match of the refraction indices the better the transparency obtainable after impregnation of the receiving layer configuration with the lacquer.

The most preferred pigment is a silica type, more particularly an amorphous silica having a average particle size ranging from 1 μm to 15 μm, most preferably from 2 to 10 μm. A most useful commercial compound is the amorphous precipitated silica type SIPERNAT 570, trade name from Degussa Co. It is preferably present in the receiving layer in an amount ranging from 5 g/m² to 30 g/m². It has following properties:

specific surface area (N₂ absorption): 750 m 2/g

mean particle size (Multisizer, 100 μm capillarity): 6.7 μm

DBP [DiButyl Phthalate] adsorption: 175-320 g/100 g

refractive index: 1.45 a 1.47.

Since the refractive index of a typical UV-curable lacquer composition is about 1.47 a 1.49 it is clear that there is good match with the refractive index of this particular silica type, and good transparency will be obtained.

Other usable precipitated silica types include SIPERNAT 310, 350 and 500, AEROSIL® grades from Degussa-Hüls AG, and SYLOID® types from Grace Co.

A receiving layer containing a porous alumina pigment such as MARTINOX GL-1 does not become completely transparent upon impregnation with acrylate/methacrylate-based lacquers with a refractive index of 1.47 to 1.49 because its refractive index is 1.6. However, lacquers with higher refractive indexes are possible e.g. including N-vinyl carbazole as comonomer.

The adhesion of receiving layers impregnated with a lacquer according to the method for producing an information carrier, according to the present invention, to the rigid sheet or support undergoes a strong improvement upon subsequent curing e.g. UV-hardening.

### Receiving Layer Binder

The receiving layer binder(s) can be water-soluble, solvent soluble or a latex and can be chosen from a list of compounds well-known in the art including hydroxyethyl cellulose; hydroxypropyl cellulose; hydroxyethylmethyl cellulose; hydroxypropyl methyl cellulose; hydroxybutylmethyl cellulose; methyl cellulose; sodium carboxymethyl cellulose; sodium carboxymethylhydroxethyl cellulose; water soluble ethylhydroxyethyl cellulose; cellulose sulphate; polyvinyl alcohol; vinylalcohol copolymers; polyvinyl acetate; polyvinyl acetal; polyvinyl pyrrolidone; polyacrylamide; acryl-amide/acrylic acid copolymer; polystyrene, styrene copolymers; acrylic or methacrylic polymers; styrene/acrylic copolymers; ethylene-vinylacetate copolymer; vinylmethyl ether/maleic acid copolymer; poly(2-acrylamido-2-methyl propane sulphonic acid); poly(diethylene triamine-co-adipic acid); polyvinyl pyridine; polyvinyl imidazole; polyethylene imine epichlorohydrin modified; polyethylene imine ethoxylated; polyethylene oxide; polyurethane; melamine resins; gelatin; carrageenan; dextran; gum arabic; casein; pectin; albumin; starch; collagen derivatives; collodion and agar-agar.

A preferred binder for the practice of the present invention is a polyvinylalcohol (PVA), a vinylalcohol copolymer or modified polyvinyl alcohol. Most preferably, the polyvinyl alcohol is a silanol modified polyvinyl alcohol. Most useful commercially available silanol modified polyvinyl alcohols can be found in the POVAL R polymer series, trade name of Kuraray Co., Japan. This R polymer series includes the grades R-1130, R-2105, R-2130, R-3109, which differ mainly in the viscosity of their respective aqueous solutions. The silanol groups are reactive to inorganic substances such as silica or alumina. R-polymers can be easily crosslinked by changing the pH of their aqueous solutions or by mixing with organic substances and can form water resistant films.

According to a twenty-second embodiment of the method for producing an information carrier, according to the present invention, the at least one opaque, porous layer further comprises at least one latex, preferably with the at least one opaque, porous layer providing the outermost surface of the receiving layer configuration. Upon varying the pigment/latex ratio between 1.2 and 6.5 (2, 2.2, 2.45, 2.70, 2.75, 3.5, 3.78, 4.25, 5 and 6.25) with SYLOID® W-300 as pigment it was found that the amount of ink bleeding decreased with increasing pigment/latex ratio. At too high ratios of pigment/latex the receiving layer becomes too powdery. With SYLOID® W-300 the best image sharpness was observed at a weight ratio of total pigment to total latex of 2.0 to 3.2. Furthermore, the presence of very high latex concentrations prohibitively reduces the rub-resistance of the printed image.

According to a twenty-third embodiment of the method for producing an information carrier, according to the present invention, the at least one opaque, porous layer comprises at least one latex and the weight ratio of total pigment to total latex is in the range 1.2:1 to 6.5:1.

If the outermost layer of the receiving layer configuration is an opaque, porous layer containing latex, as the latex concentration increases bleeding of ink-jet images printed on the outermost surface of the receiving layer configuration increases with the result that the raster of the ink-jet image is lost in favour of continuous tone imaging. Alternatively as the latex concentration in the outermost opaque, porous layer decreases ink-jet images on the outermost receiving layer become sharper and sharper. The best image quality was found with a total pigment to total latex of 2.0 to 3.2:1 in the case of SYLOID® W-300 as pigment. An increased latex content in the outermost layer of the receiving layer configuration also improves the offset-printability thereof.

### Layer or Element Capable of a Human-Readable or Machine-Readable Change Upon Absorbing UV, Visible or IR Radiation

The information carrier precursor used in the methods for producing an information carrier comprises a layer or element capable of a human-readable or machine-readable change upon absorbing UV, visible or IR radiation and the methods incorporate a step in which a light source is used to write a first or fourth pattern in the layer or element capable of a human-readable or machine-readable change upon absorption of UV, visible or IR radiation.

Lasers suitable for realizing the density or colour change are UV, visible and IR-lasers such as Nd—YAG, Nd—YLF, gas lasers such as CO₂, Ar and He/Ne lasers and diode lasers e.g. AlGaAs laser diodes.

Upon application of high intensity exposures with lasers the change in density is often accompanied by gas formation resulting in detectable bumps in the surface of the transparentized areas of the receiving layer configuration or in a protective layer applied to protect the coloured image on the transparentized receiving layer configuration i.e. in a detectable relief pattern.

In the context of the realization of human-readability the layer or element contains a so-called light source-markable material.

The layer or element capable of a human-readable or machine readable change upon absorbing UV, visible or IR light source radiation may contain a resin capable of absorbing radiation at a select wavelength and converting the radiation to heat. Preferably, for clear coatings, the resin is essentially colourless in the visible range but absorbs at non-visible wavelengths, such as in the ultraviolet or the infrared. The coating preferably is sufficiently absorbent at a select wavelength that the coating is heated to a desired temperature which can induce the colour change. A polyketone resin absorbs strongly at 10.6 micron, a wavelength which can be produced by a carbon dioxide laser.

Alternatively or in addition, an absorptive component that absorbs laser light and converts it to heat may be added to the resin. The absorption component may be at about 1 to 5% of the coating. Adhesion promoters that absorb in the laser wavelength range may also be used. Examples include methacrylate ester derivates and carboxylic acid species. A preferred material is Ebecryl 168 (available from UCV Chemicals, Smirna, Ga.) which absorbs at 10.6 microns.

The coating can also be a non-transparent dispersion of very small metallic particles or a thin metal film e.g. a bismuth film such as in the Mastertool™ materials from Agfa-Gevaert N.V., which upon laser exposure become transparent due to coalescence of bismuth. In general metallic films or patterns, which have excellent machine-readability, can be modified after transparentization of the at least one opaque, porous layer.

The coating may also include a pigment so that, rather than a clear and colourless coating, the coating has a desired background colour to enhance contrast of the image. The pigment is preferably an inert material. For example, for a white coating, titanium dioxide may be added. Other suitable pigments include barium sulphate, and Rhoplex beads, (e.g., Rhoplex AC 1024, available from Rohm and Haas, Philadelphia, Pa.).

The layer or element capable of a human-readable or machine readable upon absorbing UV, visible or IR light source radiation contain at least one radiation sensitive substance comprising radiation sensitive components that can be chosen for instance from the group of organic and inorganic pigments, organic, inorganic and polymeric colorants, photochromic, thermochromic, piezochromic and prechromic compounds, coloured and uncoloured precursor colorants, coloured fillers, UV stabilizers, antioxidants, flame-retardants, acid formers, photooxidants and photoreductors. In a special embodiment of the invention the radiation sensitive components are wholly or partially bonded chemically or physically to the carrier material. As carrier material can be used for instance polymers, dendritic macromolecules and zeolites. Preferably, the carrier material is porous.

The amount of radiation sensitive substance in the polymer composition according to the invention is mostly between 0.001 and 80 wt %, preferably between 0.005 and 3 wt. % and more preferably between 0.01 and 1 wt %. This percentage by weight is relative to the total weight of polymers and radiation sensitive substance.

Radiation sensitive inorganic pigments are for instance cobalt black, iron oxide (e.g. Pigment Red C.I. No. 101), manganese dioxide, barium chromate, titanium dioxide (anatase, rutile), zinc oxide, antimony trioxide, zinc sulphide, lithophone, basic lead carbonate, basic lead sulphate, basic lead silicate, chromium oxide, nickel antimony titanate, chromium hydroxide, cobalt violet, cobalt yellow, iron cyamide blue, chromium antimony titanate, manganese blue, manganese violet, cobalt blue, cobalt chromium blue, cobalt nickel grey, ultramarine blue, ultramarine pink, ultramarine violet, vermilion, zinc chromate, zinc tetroxychromate, Berlin blue, lead chromate, lead sulphochromate, lead cyanamide, molybdenum chromate, nickel titanium yellow, strontium chromate, lead sulphochromate molybdate, molybdenum orange, molybdenum red (Pigment Red C.I. No. 104), cadmium sulphide, arsenic disulphide, antimony trisulphide, cadmium sulphoselenide, zirconium silicates, such as zirconium vanadium blue and zirconium praseodymium yellow.

The activatable dye system changes colour (active colour or shade) in response to absorption of radiation by the coating. The dye system may be thermally activated or photochemically activated. The dye system is selected for compatibility with the resin and the substrate. In addition, the dye system is capable of inducing a colour change as a result of exposure to radiation at a select wavelength and intensity which does not adversely affect the resin.

In a particularly preferred embodiment of the present invention, the dye system is sufficiently robust in that colour change does not occur when the coating is exposed to conventional use conditions of the substrate, such as exposure to ambient temperatures in the range of 0-40° C., and ambient light. In preferred systems, the dye is activated at a relatively low temperature, e.g., 80-150° C., preferably 100-140° C. Preferably, the dye-producing system is colourless prior to exposure to radiation.

The dye system may induce a colour change by creating an acid-base variation in the coating. Systems of this type may use a moiety, such as a heat sensitive or photochemically activated moiety which changes acid-base characteristics upon exposure to heat or radiation (e.g., UV) and a dye component that changes colour in response to the change of acid-base characteristics of the moiety. These dyes are preferably present in the amount of about 1 to 15% of the coating formulation. Suitable dyes include leuco dyes which include fluorams and lactones that interrupt conjugation until treated with an acid. Preferred acid-catalysed leuco dyes include the Copikem 20 dyes (e.g., 3,3-bis(butyl-2-methyl-1H-indol-3-yl-1-[3H]-isobenzofuranone, colour magenta, available from Hilton-Davis, Cincinnati, Ohio). Other dyes include phenolphthalein, and other dyes that change colour when exposed to a pH change.

Suitable heat sensitive moieties that change acid-base characteristics include blocked acids, blocked amines, and chelated amines that can be photorearranged. These moieties are preferably present at about 0.5 to 5% of the coating formulation. Blocked acids include salts of weak bases and strong acids, e.g., sulphonic acid salts. A preferred blocked acid is diethylammonium trifluoromethane sulphonate (Fluorad FC-520, 3M, St. Paul, Minn.), a salt of a strong acid which dissociates when heated. Iodonium salts can also be used as thermally or optically activated acid sources. An example is diaryliodonium hexafluoroantimonate (available as SARCAT CD-1012, Satomer, Exton, Pa.). The heat-sensitive moiety may also become basic upon exposure to heat or radiation to activate a dye sensitive to basic conditions. Examples include blocked amines, such as, t-butyl carbonates, which becomes unblocked by removal of the t-butyl group upon exposure to heat. In this latter system, carbon dioxide gas is evolved upon heat exposure, causing a refractive index variation, which can improve contrast. This feature may be particularly beneficial for colourless coatings.

Photochemically activated moieties, which vary acid-base characteristics in response to absorption at select wavelengths, by, e.g., photo rearrangement, are described in U.S. Pat. No. 5,691,113, U.S. Pat. No. 5,652,280, and Palmer et al. Macromolecules, Vol. 28, No. 4, 1995, (P. 1326), the entire contents of all of which are incorporated herein by reference.

The dye system may also include an acid or base additive to neutralise components within the coating which might induce a partial colour change prior to application of laser energy. For example, a coating with a blocked acid may also be provided with a base, such as an amine, to neutralise any unwanted residual acidity in the coating. The base may be added in sufficient amount to produce a clear, colourless mixture prior to coating or curing. A preferred amine is n-methyldiethanolamine.

Examples of suitable thermochromic dyes are given in the table below together with the laser wavelengths at which thermochromic effects have been observed:

| Dye | Irradiating | |
|---|---|---|
| nr. | wavelength [nm] | Dye structure |
| 01 | 1064, 1047, 1054 | 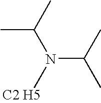 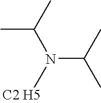 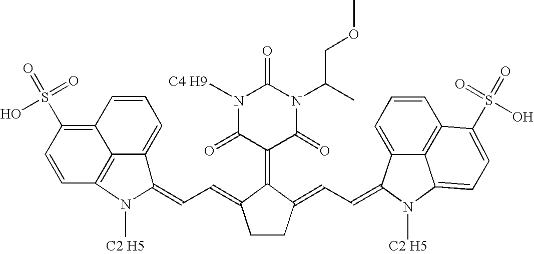 |
| 02 | 1064, 1047, 1054 | 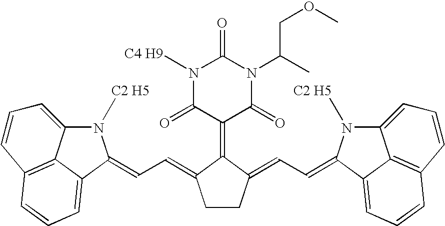 |
| 03 | 1064, 1047, 1054 | 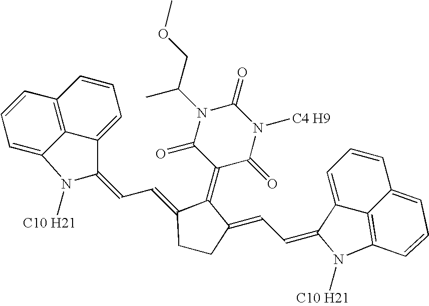 |
| 04 | 1064, 1047, 1054 | 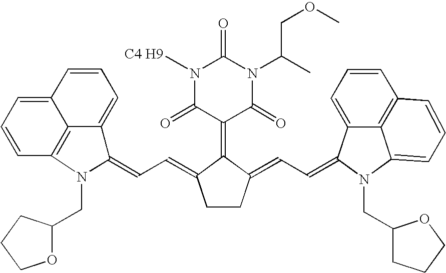 |
| 05 | 1064, 1047, 1054 | 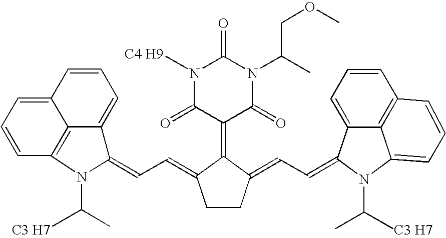 |
| 06 | 1064, 1047, 1054 | 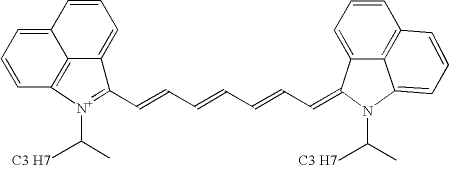 |
| 07 | 1064, 1047, 1054 | 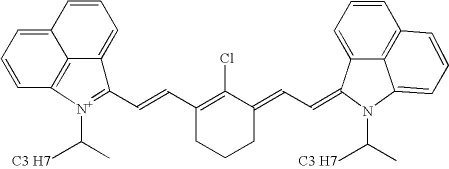 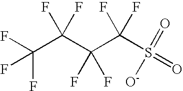 |
| 08 | 1064, 1047, 1054 | 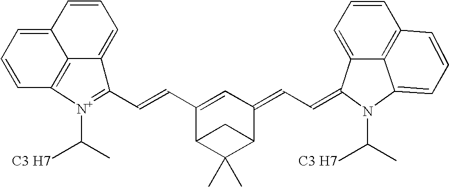 |
| 09 | 830 | 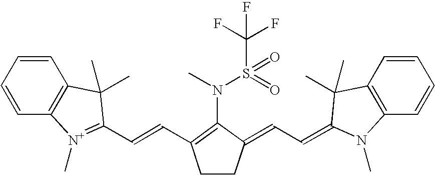 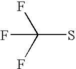 |
| 10 | 830 | 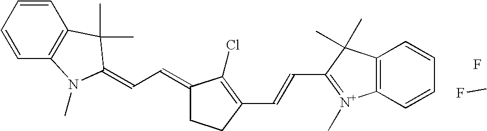 |
| 11 | 830 | 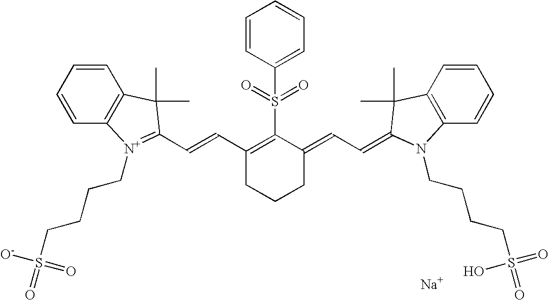 |
| 12 | 830 | 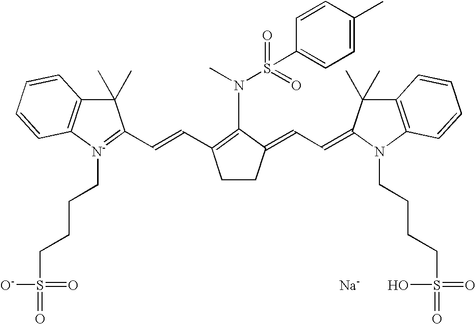 |
| 13 | 830 | 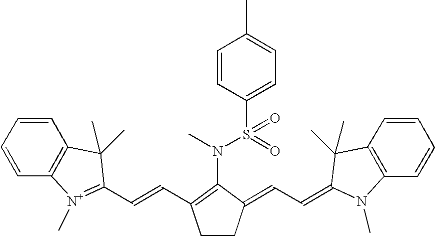 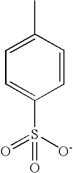 |
| 14 | 830 | 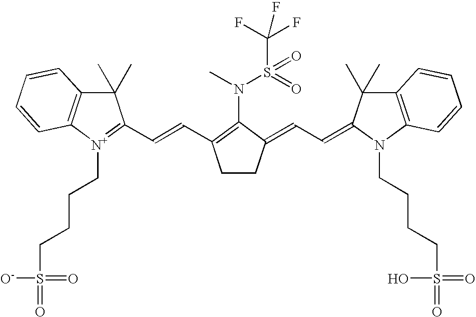 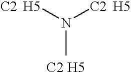 |
| 15 | 830 | 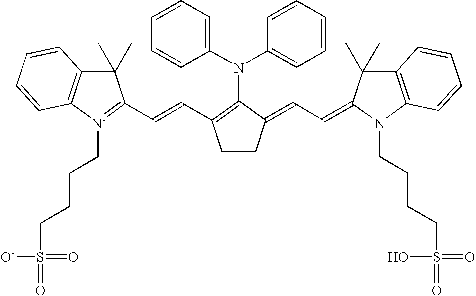 |
| 16 | 830 | 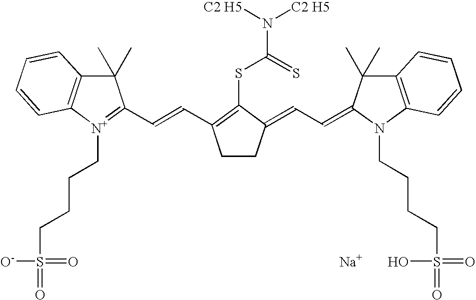 |
| 17 | 830 | 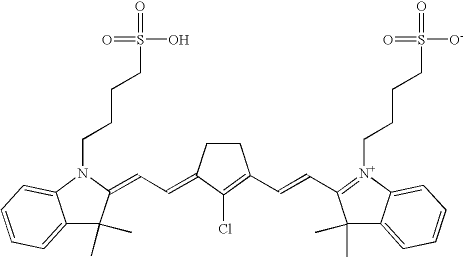 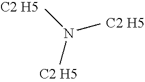 |
| 18 | 830 | 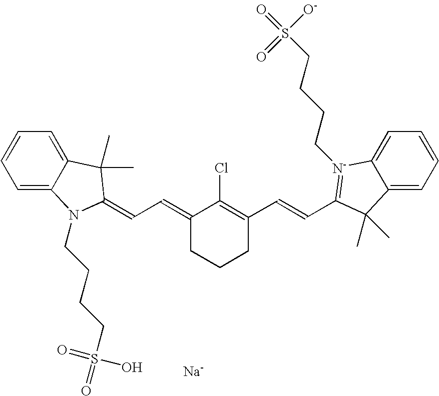 |
| 19 | 830 | 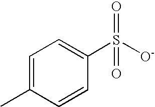 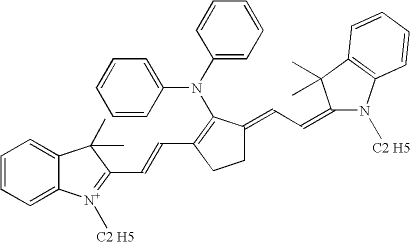 |
| 20 | 830 | 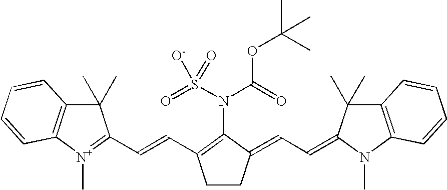 |
| 21 | 830 | |
| 21 | 830 | 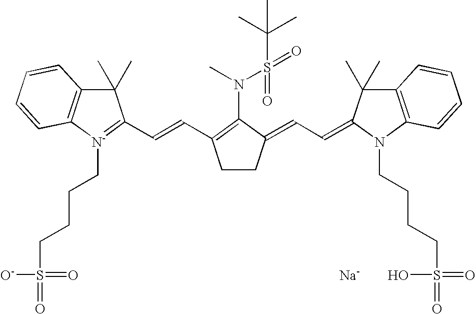 |
| 22 | 830 | 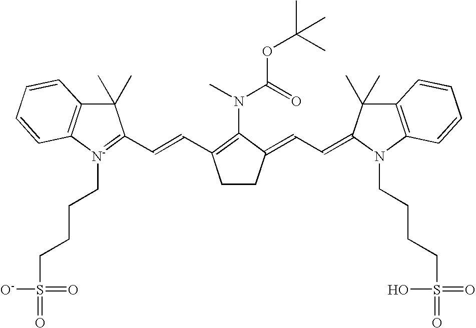 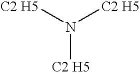 |

These dyes exhibit thermochromic effects which vary with the chemical environment existing at the moment of exposure and the colour realized upon laser exposure can also be modified by overcoating with a lacquer after laser exposure. This means that such dyes provide an extra security element with which to detect counterfeiting and falsification.

Examples of suitable thermochromic substances are given in the table below:

| | |
|---|---|
| 1,2-Benzoquinone | Azodicarbonamide |
| Citraconic acid | alpha.-lactose |
| 3-amino-1-phenyl-pyrazolone | Azobisisobutyronitrile |
| Fructose | 4-amino-3-hydroxy-butyric acid |
| Methyl yellow | 4-amino-3-hydrazino-5-mercapto-1,2,4- |
| | triazole |
| 2,3-benzoxazin-1-one | Allantoin |
| Formamidine sulphinic acid | Imino-diacetic acid |
| D (+) Maltose | Dimethylglyoxime |
| Malonic acid | Oxalic acid dihydrazide |
| 1,3-acetonedicarboxylic acid | Ethylene diamino tetra acetic acid |
| 4-aminosalicylic acid | Glycine |
| 5-anilino-1,2,3,4-thiatriazole | Hesperidin |
| 1-phenyl-5-mercapto-tetrazole | Nicotinic acid-N-oxide |
| Formamidine acetate | Phenyl-2-piperidyl-acetic acid |
| D (+) -galactose | Succinamide |
| d (−) -tartaric acid | DL-phenylalanine |
| Aminoguanidine bicarbonate | 5-amino-salicylic acid |
| Oxytetracycline | DL-methionine |
| Chinolinic acid | DL-alanine |
| Sucrose | N-hydroxyethyl ethylenediamine |
| Ascorbic acid | triacetic acid trisodium salt dihydrate |
| Methylene blue | Creatine |
| 2-hydroxy-1,4-dinaftoguinone | 2-amino octanic acid |
| 2-methyl-3-indolylacetic acid | Maleic acid dihydrazide |
| Guanidinecarbonate | Nile blue |
| p-aminophenylacetic acid | 2-hydroxy-benzimidazole |
| 5-amino-tetrazole monohydrate | 1,4-benzenedicarboxylic acid |
| .beta.-alanine | Dinicotinic acid |
| L-glutamic acid | 4,4-azobenzenedicarboxylic acid |
| Methyl violet | 6-uracilcarboxylic acid |
| L-lysine | Melamine |
| 2,4-dihydroxybenzoic acid | Guanine |
| 4-hydrazinobenzoic acid | Oxamide |

Suitable laser-markable materials include additives that form a monochrome marking in receptive coatings when exposed to laser radiation e.g. the inorganic water dispersible pigments marketed by Sherwood Technology. Examples of such pigments include: Datalase™ which forms a monochrome grey/black marking when exposed either to a 10.6 μm CO₂ laser or to a 355 nm UV laser at fluences of 100-200 on mJ/cm²; and Digilase™ which is markable with near infrared (NIR) lasers in the range of wavelengths from about 800-1064 nm at fluences of 100-200 mJ/cm². The laser-markable additive is preferably added to the ink receptive coating in concentrations falling substantially within the range from about 10-30%, and more preferably 15-25% by weight of the total weight of the formulation.

According to a twenty-fourth embodiment of the method for producing an information carrier, according to the present invention, the layer or element capable of a human-readable or machine readable change upon absorbing UV, visible or IR radiation comprises a polymer resin optionally comprising a UV, visible or IR-absorbing dye or pigment, said polymer resin preferably being polycarbonate.

Laser-markability of polymer resin-containing layers is due to the presence of laser-absorbing ingredients and marking as colour-changes including bleaching can be observed in the layer or support itself or as colour changes in coloured patterns overlying an opaque resin layer or support.

According to a twenty-fifth embodiment of the method for producing an information carrier, according to the present invention, the layer or element capable of a human-readable or machine readable change upon absorbing radiation comprises polycarbonate. Furthermore, surprisingly the optical density realized with polycarbonate upon exposure with an IR-laser through the transparentized receiving layer configuration, as used in the method for producing an information carrier, according to the present invention, is higher under the same exposure conditions than realized with an opaque polycarbonate covered with a transparent polycarbonate protective foil, the standard configuration in polycarbonate-based information carriers.

According to a twenty-sixth embodiment of the method for producing an information carrier, according to the present invention, the layer or element capable of a human-readable or machine-readable change upon absorbing UV, visible or IR radiation comprises a polymer resin, a UV, visible or IR absorbing dye or pigment and a heat-sensitive colour-forming system.

According to a twenty-seventh embodiment of the method for producing an information carrier, according to the present invention, the layer or element capable of a human-readable or machine-readable change upon absorbing UV, visible or IR radiation comprises a UV, visible or IR absorbing dye or pigment and a heat-sensitive colour-forming system.

According to a twenty-eighth embodiment of the method for producing an information carrier, according to the present invention, the layer or element capable of a human-readable or machine-readable change upon absorbing UV, visible, IR radiation comprises a polymer resin, a UV, visible or IR absorbing dye or pigment, a leuco-dye and an oxidizing agent or an acid in thermally working relationship therewith.

According to a twenty-ninth embodiment of the method for producing an information carrier, according to the present invention, the layer or element capable of a human-readable or machine-readable change upon absorbing UV, visible, IR radiation comprises a UV, visible or IR absorbing dye or pigment, a leuco-dye and an oxidizing agent or an acid in thermally working relationship therewith.

According to a thirtieth embodiment of the method for producing an information carrier, according to the present invention, the layer or element capable of a human-readable or machine-readable change upon absorbing UV, visible or IR radiation comprises a polymer resin, a UV, visible or IR absorbing dye or pigment, a substantially light-insensitive organometallic compound and a reducing agent therefor in thermally working relationship therewith.

### Rigid Sheet or Support

According to a thirty-first embodiment of the method for producing an information carrier, according to the present invention, the rigid sheet or support comprises at least one layer and/or a multilayered laminate or co-extrudate. Such multilayer laminates include paper/polymer laminates. Examples of suitable co-extrudates are PET/PETG and PET/polycarbonate.

The support can be a sheet or web support. According to a thirty-second embodiment of the information carrier precursor, according to the present invention, the support is a web support.

The support for use in the present invention can be transparent, translucent or opaque, and can be chosen from paper type and polymeric type supports well-known from photographic technology. Paper types include plain paper, cast coated paper, polyethylene coated paper and polypropylene coated paper. Polymeric supports include cellulose acetate propionate or cellulose acetate butyrate, polyesters such as polyethylene terephthalate and polyethylene naphthalate, polyamides, polycarbonates, polyimides, polyolefins, poly(vinylacetals), polyethers and polysulphonamides. Other examples of useful high-quality polymeric supports for the present invention include opaque white polyesters and extrusion blends of polyethylene terephthalate and polypropylene. Polyester film supports and especially polyethylene terephthalate are preferred because of their excellent properties of dimensional stability. When such a polyester is used as the support material, a subbing layer may be employed to improve the bonding of the receiving layer configuration to the support. Useful subbing layers for this purpose are well known in the photographic art and include, for example, polymers of vinylidene chloride such as vinylidene chloride/acrylonitrile/acrylic acid terpolymers or vinylidene chloride/methyl acrylate/itaconic acid terpolymers.

According to a thirty-third embodiment of the method for producing an information carrier, according to the present invention, the rigid sheet or support is polyvinyl chloride, polycarbonate or polyester e.g. polyethylene terephthalate, with coloured or whitened polyvinyl chloride, polycarbonate or polyester being preferred.

According to a thirty-fourth embodiment of the method for producing an information carrier, according to the present invention, the rigid sheet or support is opacified polyvinyl chloride, polycarbonate or polyester.

### Opaque Element Between the Side of the Receiving Layer Configuration Nearer the Support and the Support

The opaque element between the side of the receiving layer configuration nearer the support and the support, as used in the method for producing an information carrier, according to the present invention, can comprise any polymeric resin. Particularly suitable resins include cellulose acetate propionate or cellulose acetate butyrate, polyesters such as polyethylene terephthalate and polyethylene naphthalate, polyamides, polycarbonates, polyimides, polyolefins, poly(vinylacetals), polyethers and polysulphonamides. Other examples of useful high-quality polymeric supports for the present invention include opaque white polyesters and extrusion blends of polyethylene terephthalate and polypropylene. Opaque polyvinylchloride, polycarbonate and polyester films are preferred because of their excellent properties of dimensional stability. When such polyvinylchloride, polycarbonate and polyester films are used as the opaque element, a subbing layer may be employed to improve the bonding of the opaque element to contiguous elements or layers. Useful subbing layers for this purpose are well known in the photographic art and include, for example, polymers of vinylidene chloride such as vinylidene chloride/acrylonitrile/acrylic acid terpolymers or vinylidene chloride/methyl acrylate/itaconic acid terpolymers.

If there is an opaque element between the side of the receiving layer configuration nearer the support and the support the support can be either transparent or opaque.

According to a thirty-fifth embodiment of the method for producing an information carrier, according to the present invention, the opaque element between the side of the receiving layer configuration nearer the support and the support is non-contiguous with the receiving layer configuration and is preprinted with a security print e.g. with any security feature.

According to a thirty-sixth embodiment of the method for producing an information carrier, according to the present invention, the opaque element between the side of the receiving layer configuration nearer the support and the support is non-contiguous with the receiving layer configuration and comprises polyvinyl chloride, polycarbonate or polyester e.g. poly(ethylene terephthalate).

### Transparentizing Lacquer Compositions

The substantial penetration of the receiving layer configuration by the lacquer can be realized by controlling the penetration time and/or the wetting properties and/or the viscosity of the composition. The viscosity of the transparentizing lacquer composition is adjusted to ensure rapid penetration and hence rapid transparentization.

According to a thirty-seventh embodiment of the method for producing an information carrier, according to the present invention, the lacquer is a curable lacquer e.g. thermally curable, electron beam curable or photopolymerizable.

According to a thirty-eighth embodiment of the method for producing an information carrier, according to the present invention, the lacquer is a radiation curable lacquer.

According to a thirty-ninth embodiment of the method for producing an information carrier, according to the present invention, the lacquer is a photopolymerizable lacquer.

Transparentization process depends upon the refraction indices of the pigment and of the lacquer which penetrates the receiving layer configuration matching each other as closely as possible. The closer the match of the refraction indices the better the transparency that will be obtained after impregnation of the receiver layer with the lacquer. Therefore, the choice of ingredients for the lacquer has to be such as to fulfil this requirement. Additional constraints on the composition of the lacquer are determined by whether the lacquer is required to be curable and if curable which curing process has been selected.

According to a fortieth embodiment of the method for producing an information carrier, according to the present invention, the refractive index of the pigment and the refractive index of the transparentizing lacquer differ by no more than 0.1.

According to a forty-first embodiment of the method for producing an information carrier, according to the present invention, the refractive index of the pigment and the refractive index of the transparentizing lacquer differ by no more than 0.04.

According to a forty-second embodiment of the method for producing an information carrier, according to the present invention, the refractive index of the pigment and the refractive index of the transparentizing lacquer differ by no more than 0.02.

Refractive indices of representative polymers are given below:

| | Refractive index for sodium |
|---|---|
| | line at 589.3 nm [ASTM D642] |
| polystyrene | 1.57-1.60 |
| poly-α-methyl-styrene | 1.610 |
| poly-4-methyl-styrene | — |
| poly-α-vinyl-naphthalene | 1.6818 |
| polyacrylonitrile | 1.514, 1.5187 |
| polymethacrylonitrile | 1.520 |
| polymethyl methacrylate | 1.49, 1.4893 |
| polyacrylamide | — |
| copolymer of acrylonitrile and styrene | 1.56-1.57, 1.57 |
| copolymer of 28.5 wt % acrylonitrile | 1.56-1.57, 1.57 |
| and 71.5 wt % styrene | |

An essential ingredient of a curable lacquer is at least one monomer. In the case of the curable lacquer being a photopolymerizable lacquer the lacquer will further contain at least one photoinitiator.

The refractive index of curable lacquers based on acrylates and methacrylates are there typically 1.47 to 1.49 and hence the use of such compositions as lacquers, according to the present invention, will provide a good match with the refractive index of SIPERNAT 570 with a refractive index of 1.45 to 1.47, and hence good transparency is obtained.

Suitable monomers for use in curable lacquers include the monomers disclosed in DE-OS 4005231, DE-OS 3516256, DE-OS 3516257, DE-OS 3632657 and U.S. Pat. No. 4,629,676, unsaturated esters of polyols, particularly such esters of the α-methylene carboxylic acids, e.g. ethylene diacrylate, glycerol tri(meth)acrylate, diethylene glycol di(meth)acrylate, 1,3-propanediol di(meth)acrylate, 1,2,4-butanetriol tri(meth)acrylate, 1,4-cyclohexanediol di(meth)acrylate, 1,4-benzenediol di(meth)acrylate, pentaerythritol tetra(meth)acrylate, pentaerythritol triacrylate, dipentaerythritol pentacrylate, trimethylolpropane triacrylate, 1,5-pentadiol di(meth)acrylate, the bis-acrylates and bis-methacrylates of polyethylene glycols of molecular weight 200-500; unsaturated amides, particularly those of the α-methylene carboxylic acids, and especially those of α,ω-diamines and oxygen-interrupted ω-diamines, such as bis-acrylamide, methylene bis-methacrylamide, 1,6-hexamethylene bis-acrylamide, diethylene triamine tris-methacrylamide, bis(γ-methacrylamidopropoxy)ethane, β-methacryl-amidoethyl methacrylate, N-(β-hydroxyethyl)-β-(methacrylamido)ethyl acrylate, and N,N-bis(β-methacryloyl-oxyethyl)acrylamide; vinyl esters, e.g. divinyl succinate, divinyl adipate, divinyl phthalate, divinyl butane-1,4-disulphonate; and unsaturated aldehydes, e.g. sorbaldehyde (hexadienal).

Curable lacquers may also comprise polymers and/or oligomers comprising two or more different polymerizable functions, e.g. acrylated epoxies, polyester acrylates, urethane acrylates, etc.

It is also possible to use monofunctional (meth)acrylic acid esters as monomer provided they are not to volatile and do not spread an unwanted odour. Suitable compounds include n-octylacrylate, decylacrylate, decylmethacrylate, stearylacrylate, stearylmethacrylate, cyclohexylacrylate, cyclohexylmethacrylate, phenylethylacrylate, phenylethylmethacrylate. The most preferred compounds comprise one or more (meth)acrylate functional groups.

Preferred monomers for use in UV-curable photopolymerizable compositions have at least one (meth)acrylate functional group, such as those disclosed in EP-A 0 502 562.

A non-exhaustive list of monomers including commercially available compounds (chemical and commercial names) suitable for use in the transparentizing curable compositions used in the method for producing an information carrier, according to the present invention, is given below:

### Monomers/Oligomers:

### (Chemical Name; Type, Vendor)

pentaerythritol triacrylate; SR-444 (Sartomer)

trimethylolpropane triacrylate; SR-351 (Sartomer)

dipropyleneglycol diacrylate; SR-508 (Sartomer)

amine modified polyether acrylate oligomer; CN-501 (Sartomer)

isobornyl acrylate; SR-506 (Sartomer)

diethyleneglycol divinylether; RAPI-CURE DVE-2 (ISP)

triethyleneglycol divinylether; RAPI-CURE DVE-3 (ISP)

urethane acrylate blended with 2(2-ethoxyethoxy)ethylacrylate (SR-256); CN-966H90 (Sartomer)

polybutadiene dimethyl acrylate; CN-301 (Sartomer)

low viscosity oligomer; CN-135 (Sartomer)

low viscosity oligomer; CN-137 (Sartomer)

A wide variety of photopolymerizable and photocrosslinkable compounds can be used in the present invention. Suitable photoinitiators include all compounds or compound combinations known for this purpose. Examples are benzoin ethers, benzil ketals, polycyclic quinones, benzophenone derivatives, triarylimidazolyl dimers, photosensitive trihalomethyl compounds, for example trichloromethyl-s-triazines. Preferred photoinitiators are the 2,3-bisarylquinoxalines, as disclosed in U.S. Pat. No. 3,765,898, and 2-aryl-4,6-bistrichloromethyl-s-triazines. The amount of photoinitiator or photoinitiator combination is generally between 1 and 25% by weight of the photopolymerizable composition and preferably between 5 and 15% by weight.

Non-exhaustive lists of photoinitiators and thermal initiators including commercially available compounds (chemical and commercial names) suitable for use in the transparentizing curable compositions used in the method for producing an information carrier, according to the present invention, are given below:

### Photoinitiators:

IRGACURE 907 (from Ciba-Geigy Co.)

NOVOPOL PI3000 (from Rahn Co.)

GENOCURE DEAP (from Rahn Co.)

IRGACURE 184 (from Ciba-Geigy Co.)

EZACURE KK (from Fratelli Lamberti Co.)

IRGACURE 500 (from Ciba-Geigy Co.)

IRGACURE 819 (from Ciba-Geigy Co.)

### Thermal Initiators

AIBN-dicumyl peroxide-benzoyl peroxide-t-butyl peroxide-VAZO compounds (from DuPont Co.), e.g. VAZO 52-LUPEROX (from Atofina Co.), e.g. 233, 10, 11, 231, 101, hydroperoxides, and peresters.

Photopolymerizable lacquers may also contain a minor amount of a heat polymerization inhibitor which prevents premature polymerization before the UV curing step. Examples of such inhibitors include p-methoxyphenol, hydroquinone, aryl- or alkyl substituted hydroquinone, t-butylcatechol, pyrogallol, copper(I) chloride, phenothiazine, chloranil, naphtylamine, α-naphtol, 2,6-di-t-butyl-p-cresol, etc. A preferred polymerization inhibitor is 2-methyl hydroquinone. The heat polymerization inhibitors are preferable used in an amount of 0.001 to 5 parts by weight per 100 parts of monomer.

Curable lacquers may optionally contain a minor amount of organic solvent. Suitable solvents for use in the transparentizing curable compositions used in the method for producing an information carrier, according to the present invention, include ethyl acetate, acetone, methylethylketone, tetrahydrofuran, ethanol and N-methylpyrrolidone.

According to a forty-third embodiment of the method for producing an information carrier, according to the present invention, the lacquer further contains at least one colorant e.g. a dye or a pigment.

### Non-Transparentizing Lacquer Composition

Non-transparentizing lacquer compositions giving an at least partially opaque background are also capable of penetrating into the at least one opaque, porous layer, but will have a refractive index that differs too much from the refractive index of the pigment, so that it is not capable to render the receiving layer configuration i.e. significantly more than 0.12 units above or below the refractive index of the pigment used in the receiving layer configuration e.g. by using vinyl carbazole or α-vinyl-naphthalene as the sole or comonomer (polyvinyl carbazole and poly-α-vinyl-naphthalene have refractive indices of 1.695 and 1.6818 respectively), with more than 0.13 units above or below the refractive index of the pigment used in the receiving layer configuration being preferred.

The refractive index of curable lacquers based on styrenes are typically ca. 1.60 and hence the use of such compositions as lacquers, according to the present invention, will provide a good match with the refractive index of SIPERNAT 570 with a refractive index of 1.45 to 1.47, and hence no transparency is obtained. Lacquers with even higher refractive indices are possible e.g. those including N-vinyl carbazole as comonomer. Alternatively the use of acrylate/methacrylate-based lacquers with a refractive index of 1.47 to 1.49 with receiving layer configurations comprising a porous alumina pigment such as MARTINOX GL-1 with a refractive index of 1.6 also ensures that no transparency is obtained.

### Information Carrier

According to a forty-fourth embodiment of the method for producing an information carrier, according to the present invention, the information carrier is an identification card selected from the group consisting of an identity card, a security card, a driver's license card, a social security card, a health card, a membership card, a time registration card, a bank card, a pay card, credit card and a passport page.

Most types of ID cards have now the standardized dimensions of 85.6 mm×54.0 mm×0.76 mm. This final thickness can be reached by thermal lamination of one or more polymeric foils, e.g. PVC foils. The finished ID card can serve as an identity card, a security card, a driver's license card, a social security card, a bank card, a membership card, a time registration card, a pay card and a credit card, etc.

Apart from the features described above the finished ID card may comprise additional security elements or information carriers such as a hologram, a magnetic strip, or a chip (“smart cards”).

According to a forty-fifth embodiment of the method for producing an information carrier, according to the present invention, the information carrier is in the form of a flexible sheet e.g. a security document, any page of a passport or a page of a passport with personalized data of the bearer.

According to a forty-sixth embodiment of the method for producing an information carrier, according to the present invention, the information carrier is an admission document e.g. a visa, a ticket for an event and lottery tickets.

The present invention will now be illustrated by the following examples without however being limited thereto. The percentages and ratios given in these examples are by weight unless otherwise indicated.

### EXAMPLES

### Materials, Dispersions and Materials Used in the Examples

### Subbing Layers:

The coating solution for subbing layer No. 01 has the following composition and was coated at 130 m²/l:

| | | |
|---|---|---|
| Copolymer of 88% vinylidene chloride, 10% methyl | 68.8 | g |
| acrylate and 2% itaconic acid | | |
| Kieselsol ™ 100 F., a colloidal silica from BAYER | 16.7 | g |
| Mersolat ™ H, a surfactant from BAYER | 0.36 | g |
| Ultravon ™ W, a surfactant from CIBA-GEIGY | 1.68 | g |
| Water to make | 1000 | g |

The coating solution for subbing layer No. O₂ has the following composition and was coated at 30 m²/l:

| | | |
|---|---|---|
| Gelatin | 11.4 | g |
| Kieselsol ™ 100 F-30, a colloidal silica from BAYER | 10.08 | g |
| Ultravon ™ W, a surfactant from CIBA-GEIGY | 0.4 | g |
| Arkopal ™, a surfactant from CLARIANT | 0.2 | g |
| Hexylene glycol | 0.67 | g |
| Trimethylolpropane | 0.33 | g |
| Copolymer of 74% maleic acid, 25% styrene and 1% | 0.03 | g |
| methylmethacrylate | | |
| Water to make | 1000 | g |

### Gelatin Layers:

The coating solution for the gelatin layer No. 01 has the following composition and was coated at 35 m²/l:

| | |
|---|---|
| Gelatin | 40 g |
| Hostapon ™ T, a surfactant from CLARIANT | 1 g |
| Formaldehyde (4%) | 40 g |
| Water to make | 1000 g |

### Physical Development Layers:

The coating solution for the physical development No. 01 has the following composition and was coated with a 20 μm Braive coating knife:

| | |
|---|---|
| Palladium sulphide physical development nuclei | 200 g |
| dispersion | |
| Zonyl ™ FSO-100, a surfactant from DUPONT | 0.5 g |
| Water to make | 1000 g |

The preparation of the palladium sulphide physical development nuclei is described in the example of EP-A 0 769 723, herein incorporated by reference. From this example, solutions A1, B1 and C1 were used to prepare a nuclei dispersion with a concentration of 0.0038 mol/l.

### Receiving Media:

| Receiving | |
|---|---|
| medium nr | |
| 1 | 125 μm PET with an adhesion promoting layer No. 01, |
| | subbing layer No. 02 and physical development layer No. 01 |
| 2 | 125 μm PET with an adhesion promoting layer No. 01, |
| | subbing layer No. 02, gelatin layer No. 01 and physical |
| | development layer No. 01 |
| 3 | PET-SAN with physical development layer No. 01 |
| 4* | A laminate of 63 μm PET with 30 μm PET-G |
| | (glycol-modified PET), with physical development layer |
| | No. 01 on the PET-G side |

*PETC/PETG = 63 μm PET-C (Agfa) met V123/01 + X109/01 op achterzijde en V116/01 + R118/03 op voorzijde. 30 μm dikke PET-G film wordt bij Amcor verlijmd op de R-laag.

### Invention Example 1

A 100 μm thick sheet of transparent polyethylene terephthalate subbed with subbing layer 1 was coated with subbing layer No 1 and then with the porous receiver layer dispersion with the composition given in table 1:

TABLE 1
Composition of porous receiver layer solution.

| | | |
|---|---|---|
| Syloid ™ W300, a colloidal silica from GRACE GMBH | 75.6 | g |
| Poval PVA R3109, a silanol modified polyvinyl alcohol from | 2.3 | g |
| KURARAY CO. | | |
| Catfloc ™ T2, a cationic polyelectrolyte from | 5.6 | g |
| CALGON EUROPE | | |
| Bronidox ™ K, a biocide from HENKEL | 0.3 | g |
| (5% solution in ethanol) | | |
| Citric acid | 0.3 | g |
| Polysol ™ EVA P-550, a 50% aqueous emulsion of | 100 | g |
| an ethylene-vinyl acetate-vinyl versatate copolymer | | |
| from SHOWA HIGH POLYMER CO. | | |
| Aerosol ™ OT, a surfactant from CYTEC | 1.5 | g |
| Tergitol ™ 4, a surfactant from UNION CARBIDE | 1 | g |
| Water to make | 1000 | g |

using a 100 μm wirebar followed by drying at 50° C. producing an opaque porous layer with a layer thickness of 22 μm and an optical density of 0.19 measured with a MacBeth RB918-SB densitomer with a visible filter and with a black sheet of cardboard with a density of 1.35 placed under the transparent polyethylene terephthalate support. With a white background beneath the transparent polyethylene terephthalate support an optical density of 0.06 was measured with a visible filter indicating a certain transparency, although the “opaque” porous layer provides a white non-transparent film due to the extremely high haze of the layer of 97% as measured with a Haze-Gard Plus apparatus from BYK-GARDNER according to ASTM D1003.

Model experiments were carried out with liquids to determine what refractive index difference was acceptable with the above-described opaque porous layer without a prohibitive decrease in optical density. The results are given in Table 2 together with the optical density obtained upon transparentization with the lacquer with the composition given in Table 3 below:

TABLE 2

| | Refractive index at | Optical density (visible filter) |
|---|---|---|
| | 20° C. with sodium | of “opaque” porous layer |
| Liquid | line at 589.3 nm | upon wetting with the liquid |
| deionized water | 1.3325 | 0.70 |
| methylethylketone | 1.379 | 1.13 |
| dichloromethane | 1.4241 | 1.26 |
| toluene | 1.497 | 1.37 |
| lacquer given in | | 1.40 |
| Table 3 | | |

### On the basis of the optical density achieved with the lacquer given in Table 3, extrapolation gives a value for the refractive index of the pigment in the opaque porous layer of ca. 1.52.

The opaque porous layer was then overcoated with the lacquer given in Table 3 below with a 50 μm wirebar. The layer had an optical density of 1.40 and a haze of 6% measured as described above.

TABLE 3
Composition of UV curable transparent lacquer

| | |
|---|---|
| Isobornylacrylate | 416.2 g |
| Actilane ™ 411, a monofunctional acrylate diluent from AKZO | 247.7 g |
| NOBEL | |
| Ebecryl ™ 1039, an urethanemonoacrylate from | 178.4 g |
| UCB CHEMICALS | |
| Ebecryl ™ 11, a polyethylene glycol diacrylate from UCB | 99.1 g |
| CHEMICALS | |
| Irgacure ™ 500, a photo-initiator from CIBA-GEIGY | 49.6 g |
| Perenol ™ S Konz (50% in ethyl acetate), a surfactant from | 9 g |
| HENKEL | |

### Invention Example 2

A silver layer was deposited on Receiving medium nr 1 via a diffusion transfer reversal (DTR) process by bringing transfer emulsion layer NPC6 (Copyproof Negative Film from AGFA-GEVAERT™) in contact with the physical development layer No. 01 of Receiving medium 1 at 25° C. for 1 minute with an AGFA-GEVAERT™ CP297 developer solution and subsequently drying at room temperature. A diffractive pattern was created in the substrate by hot embossing with a nickel shim (DIFTONE from AVANTONE OY), utilizing an Interlock Cardjet laminator. The laminator temperature was set to 200° C. and the pressure was set to 1000 Kg.

Receiving medium nr. 1 was coated with a porous receiver layer dispersion with the composition given in Table 1 in INVENTION EXAMPLE 1 using a 100 μm wirebar and the layer dried at 50° C. Due to the opaque layer, the diffractive pattern was no longer visible.

The porous receiver layer was then overcoated with a UV curable transparent lacquer (composition shown in Table 3 of INVENTION EXAMPLE 1) using a 50 μm wirebar. About two minutes after the application of the solution curing was performed by means of a DRSE-120 conveyor with VPS/1600 UV lamp (speed 20 m/min, 50% UV power setting). To obtain a complete curing three passes were necessary. Due to the complete penetration of the UV lacquer in the ink receiver layer, the latter became totally transparent so that the underlying diffractive pattern became clearly visible. Finally, Scotchgard™ Phototool Protector (from 3M) was applied with a 10 μm wirebar and cured by means of a DRSE-120 conveyor with VPS/1600 UV lamp (speed 20 m/min, 100% UV power setting, one pass).

The prepared sample was exposed by full area scanning with a Nd:YAG laser emitting at 1064 nm in three different areas on the sample. The image plane power was set at 150, 250 and 450 mW respectively for each area. A spot size of 18 μm was used together with a pitch of 10 μm at a scan speed of 0.5 m/s. In the exposed areas, the silver layer showed a decreased reflectance and the diffractive pattern was no longer visible.

### Invention Example 3

INVENTION EXAMPLE 2 was repeated using RECEIVING MEDIA nr. 2 and 3. The diffractive pattern was clearly visible on both substrates after application of the UV curable transparent lacquer.

After laser exposure, the silver layers showed a decreased reflectance and the diffractive patterns were no longer visible.

### Invention Example 4

INVENTION EXAMPLE 2 was repeated using RECEIVING MEDIA nr. 1 to 4, but with the following differences: a) The substrates were first hot embossed and secondly the silver layer was deposited via the DTR process, b) substrate 4 was embossed at a temperature of 110° C.

The diffractive pattern was clearly visible on all substrates after application of the UV curable transparent lacquer.

After laser exposure, the silver layers showed a decreased reflectance and the diffractive patterns were no longer visible on substrates 2 and 3 and only very faintly on substrates 1 and 4.

### Invention Example 5

INVENTION EXAMPLE 4 was repeated using RECEIVING MEDIUM nr. 3, but with the difference that a diode laser emitting at 830 nm was used. The image plane power was set at 64, 99 and 116 mW respectively for three different areas. A spot size of 10.5 μm was used together with a pitch of 6 μm at a scan speed of 0.5 m/s. In the exposed areas, the silver layer showed a decreased reflectance and the diffractive pattern was no longer visible.

### Invention Example 6

INVENTION EXAMPLE 2 was repeated using RECEIVING MEDIA 2 and 4, but with the following differences: a) The receiving media were first hot embossed, secondly overcoated with the porous receiver layer solution and thirdly the silver layer was deposited via the DTR process, b) substrate 4 was embossed at a temperature of 110° C.

The diffractive pattern was visible on both substrates after application of the UV curable transparent lacquer.

After laser exposure, the silver layers showed a decreased reflectance and the diffractive patterns were no longer.

### Comparative Example 1

INVENTION EXAMPLE 6 was repeated using RECEIVING MEDIUM nr. 1, but with the following differences: a) the substrate was not coated with physical development layer No. 01 and b) the porous receiver layer solution described in Table 4 was used, instead of the composition shown in Table 1.

TABLE 4
Composition of porous receiver layer solution.

| | | |
|---|---|---|
| Syloid ™ W300, a colloidal silica from GRACE GMBH | 67.8 | g |
| Poval ™ PVA R3109, a silanol modified polyvinyl alcohol | 2.1 | g |
| from KURARAY CO. | | |
| Catfloc ™ T2, a cationic polyelectrolyte from CALGON | 5.0 | g |
| EUROPE | | |
| Bronidox ™ K, a biocide from HENKEL (5% solution in | 0.3 | g |
| ethanol) | | |
| Citric acid | 0.3 | g |
| Polysol ™ EVA P-550, an ethylene-vinyl acetate-vinyl | 134.5 | g |
| versatate copolymer from SHOWA HIGH POLYMER CO. | | |
| Aerosol ™ OT, a surfactant from CYTEC | 0.4 | g |
| Tergitol ™ 4, a surfactant from UNION CARBIDE | 0.3 | g |
| Palladium sulphide physical development nuclei dispersion | 89.7 | g |
| Water to make | 1000 | g |

After application of the development nuclei containing porous receiver layer, the color of the receiver layer changed from white to grey during the diffusion transfer reversal (DTR) process. After overcoating with the UV curable transparent lacquer, the receiver layer became transparent grey, but no diffractive pattern could be observed, possibly because the silver was not deposited directly on the diffractive pattern as a thin layer, but instead formed a diffuse silver layer in the receiver layer configuration.

After laser exposure, the silver layer showed no change in reflectance.

### Invention Example 7

A Mastertool™ MT8 sheet from Agfa-Gevaert N.V. consisting of a polyethylene terephthalate support provided with an evaporated vacuum-deposited bismuth layer with a very high optical density (layer thickness of less than 200 nm) at a pressure in the range of 10⁻² to 8×10⁻¹ Pa, which itself was laminated on line with a polyethylene terephthalate protective foil with a pressure-sensitive adhesive layer, as described in EP 0 384 041A1 (see apparatus in FIG. 1), was coated with subbing layer No 1 and then with the porous receiver layer dispersion with the composition given in Table 1 using a 100 μm wirebar followed by drying at 50° C. as described for INVENTION EXAMPLE 1. A multicolor ink-jetted image was then applied using an EPSON R300 ink-jet printer with dye-based aqueous inks to part of the porous receiver layer.

Part of the porous receiver layer was then transparentized including the porous receiver layer under part of the multicolor ink-jet image by coating with a 50 μm wirebar the UV curable transparentizing lacquer composition given in Table 3 as described for INVENTION EXAMPLE 1.

The bismuth layer was then exposed with an IR laser through the thereby transparentized porous receiving layer both in areas with the multicolor ink-jet image and areas without the multicolor ink-jet. Surprisingly the optical density in the laser-exposed areas of the were rendered transparent due to the bismuth being agglomerated into beads by the IR laser radiation with no observable difference being observed in the transparentization of the bismuth layer between areas with a multicolor ink-jet image and areas without a multicolor ink-jet image i.e. the presence of the ink-jet image neither hinders the transparentization process with the UV-hardenable lacquer nor the subsequent transparentization of the bismuth layer. No transparentization of the bismuth layer occurred upon laser exposure of the bismuth layer through the non-transparentized opaque porous receiver layer with or without a multicolor ink-jet image on its surface.

### Invention Example 8

The opaque porous layer configuration of INVENTION EXAMPLE 1 was repeated with a number of variants as summarized below. The opaque porous layer described in INVENTION EXAMPLE 1 was coated to a coverage of ca. 1 mg/cm² with DYES 9, 10, 12, 14, 15, 17, 18, 19, 21 and 22 from a 1 wt % solutions of the dyes. Three experiments were carried out with each dye: i) exposure of the dye-coated porous layer to a 150 mW IR-laser diode at 830 nm at energies in the range of 0.39 to 1.25 J/cm²; ii) exposure of the dye-coated areas of the porous layer to a 150 mW IR-laser diode at 830 nm at energies in the range of 0.39 to 1.25 J/cm² followed by the lacquer given in Table 3 of INVENTION 1 under the conditions described in INVENTION 1; and iii) coating of the dye-coated porous layer with the lacquer given in Table 3 of INVENTION 1 under the conditions described in INVENTION 1 followed by exposure of the dye-coated areas porous layer to a 150 mW IR-laser diode at 830 nm at energies in the range of 0.39 to 1.25 J/cm². The resulting samples (SAMPLES 1 to 30) were evaluated visually and the results summarized in Table 4.

TABLE 4

| | Coating | | IR | | IR | Degree | |
|---|---|---|---|---|---|---|---|
| | with | Coat | laser | Coat | laser | of | |
| Sample | macroporous | with | exposure | with | exposure | colour | Colour change upon laser |
| nr. | layer | dye | [nm] | Lacquer | [nm] | change | exposure |
| 1 | yes | 09 | 830 | | | ++ | blue-green → slate-blue |
| 2 | yes | 09 | 830 | yes | | + | mauve → dark-mauve |
| 3 | yes | 09 | | yes | 830 | none | pink-red |
| 4 | yes | 10 | 830 | | | + | blue-green → grey-blue |
| 5 | yes | 10 | 830 | yes | | + | light yellow-green → |
| | | | | | | | ochre yellow |
| 6 | yes | 10 | | yes | 830 | none | yellow-ochre |
| 7 | yes | 12 | 830 | | | ++ | sea-green → purple |
| 8 | yes | 12 | 830 | yes | | ++ | blue-green → purple |
| 9 | yes | 12 | | yes | 830 | + | pink-purple → purple |
| 10 | yes | 14 | 830 | | | ++ | sea-green → purple |
| 11 | yes | 14 | 830 | yes | | ++ | blue-green → purple |
| 12 | yes | 14 | | yes | 830 | ++ | purple-pink → purple |
| 13 | yes | 15 | 830 | | | ++ | deep green → mauve |
| 14 | yes | 15 | 830 | yes | | ++ | deep sea green → |
| | | | | | | | grey-pink |
| 15 | yes | 15 | | yes | 830 | + | dark blue-green → |
| | | | | | | | grey/pink |
| 16 | yes | 17 | 830 | | | ++ | blue-green → brown |
| 17 | yes | 17 | 830 | yes | | + | green/grown → light-brown |
| 18 | yes | 17 | | yes | 830 | none | light mauve |
| 19 | yes | 18 | 830 | | | + | dark yellow-green → |
| | | | | | | | dark olive |
| 20 | yes | 18 | 830 | yes | | + | light yellow-green → |
| | | | | | | | olive |
| 21 | yes | 18 | | yes | 830 | none | yellow-green |
| 22 | yes | 19 | 830 | | | + | dark blue-green → blue-brown |
| 23 | yes | 19 | 830 | yes | | + | blue-green → light |
| | | | | | | | blue-green |
| 24 | yes | 19 | | yes | 830 | none | grey-brown |
| 25 | yes | 21 | 830 | | | + | sea-green → mauve |
| 26 | yes | 21 | 830 | yes | | + | brown → blue-brown |
| 27 | yes | 21 | | yes | 830 | none | dark blue-green |
| 28 | yes | 22 | 830 | yes | | ++ | light brown-green → |
| | | | | | | | light purple |
| 29 | yes | 22 | 830 | yes | | + | light brown-green → |
| | | | | | | | light purple |
| 30 | yes | 22 | | yes | 830 | none | light brown |

The data in Table 4 shows that the dyes are thermochromic. Furthermore, the colour changes for laser exposure of SAMPLES 13, 14 and 15 with DYE 15 in different environments were all different and visually distinguishable from one another. This is an added security feature, since it makes counterfeiting impossible. Similarly the colour changes for laser exposure of SAMPLES 7, 8 and 9 with DYE 12 also in different environments were all different and visually distinguishable from each other as were those for the laser exposure of SAMPLES 10, 11 and 12 with DYE 14.

### Invention Example 9

In a further variant on INVENTION EXAMPLE 1, the 100 μm thick polyethylene terephthalate support used in INVENTION EXAMPLE 1 was replaced by a blank Certipos® “Belgian Identity Card” available from Certipost N.V. (Ninovesteenweg 196, B-9320 Erembodegem). The Certipost® cards are polycarbonate-based. A side of the Certipost® card was coated with the opaque porous composition given in Table 1 to a thickness of 100 μm and then dried at 60° C. for several minutes in a drying cupboard. Half of the resulting porous layer was coated with the lacquer composition given in Table 3 of INVENTION EXAMPLE 1 to a thickness of 30 μm and then cured by passing the resulting card with the opaque porous layer transparentized where it has been penetrated with the lacquer through a DRSE-120 Fusion UV-curing unit at maximum power and a speed of 20 m/min. Laser engraving of the resulting polycarbonate support coated with a transparentized opaque porous layer with a Maurer M550 laser engraver was surprisingly able to engrave an image of a human face and personalization data into the polycarbonate beneath the transparentized opaque porous layer.

Having described in detail preferred embodiments of the current invention, it will now be apparent to those skilled in the art that numerous modifications can be made therein without departing from the scope of the invention as defined in the following claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I claim:

1. A method for producing an information carrier comprising the steps of: (1) providing an information carrier precursor comprising: a rigid sheet or support; a receiving layer configuration comprising at least one constituent layer; and a layer or element capable of a human-readable or machine-readable change upon absorbing UV, visible or IR radiation, wherein at least one layer of said receiving layer configuration is opaque, porous, has the capability of being rendered substantially transparent upon penetration by a lacquer provided at the outermost surface of said receiving layer configuration and comprises at least one pigment and at least one binder; (2) realizing a temporary transparentization pattern by applying a vaporizable liquid pattern-wise or integrally to said receiving layer configuration; (3) writing with a light source a first pattern in said layer or element capable of human readable or machine-readable change; and in any order evaporating said vaporizable liquid; applying a second pattern to the outermost layer of said receiving layer configuration; and realizing a permanent transparentization pattern by applying a lacquer pattern-wise or integrally to said receiving layer configuration; with the proviso that said lacquer is applied after said vaporizable liquid has been evaporated, thereby producing an information carrier.

2. The method according to claim 1, wherein said rigid sheet or support comprises at least one layer and/or a multilayered laminate or extrudate.

3. The method according to claim 1, wherein any of said patterns is a coloured pattern.

4. The method according to claim 1, wherein said light source is a laser.

5. The method according to claim 1, wherein said human-readable change is a density or colour change.

6. The method according to claim 1, wherein said machine-readable change is a change in light emission properties, in a conductive pattern, in an inductively readable pattern, in an electrical circuit or in a RF-readable entity.

7. The method according to claim 1, wherein said second or third pattern is applied using a conventional printing technique.

8. The method according to claim 1, wherein said pattern-wise transparentization is followed by applying a second or third pattern using a conventional printing process only to the opaque, porous parts of the outermost surface of the receiving layer configuration corresponding to the opaque, porous parts of said at least one opaque, porous layer remaining after pattern-wise transparentization.

9. The method according to claim 7, wherein said conventional printing technique is a non-impact or an impact printing technique.

10. The method according to claim 9, wherein said non-impact printing technique is selected from the group consisting of electrophotographic printing, electrophoretic printing and ink-jet printing.

11. The method according to claim 9, wherein said impact printing technique is selected from the group consisting of thermal dye transfer printing, screen printing, offset printing, gravure printing and flexographic printing.

12. The method according to claim 1, wherein, in the event of permanent pattern-wise transparentization of said at least one opaque, porous layer, the non-transparentized parts of said receiving layer configuration are penetrated with a non-transparentizing lacquer.

13. The method according to claim 1, wherein said layer or element capable of a human-readable or machine-readable change upon absorbing IR-radiation comprises a polymer resin optionally comprising an infra-red-absorbing dye or pigment.

14. The method according to claim 13, wherein said polymer resin is polycarbonate.

15. The method according to claim 1, wherein said layer or element capable of a human-readable or machine-readable change upon absorbing UV, visible or IR radiation comprises a polymer resin, a UV, visible or IR-absorbing dye or pigment and a heat-sensitive colour-forming system.

16. The method according to claim 15, wherein said heat-sensitive colour-forming system is a leuco-dye and an oxidizing agent or an acid in thermally working relationship therewith.

17. The method according to claim 15, wherein said heat-sensitive colour-forming system is a substantially light-insensitive organometallic compound and a reducing agent therefor in thermally working relationship therewith.

18. The method according to claim 1, wherein the refractive index of said pigment and the refractive index of said lacquer differ by no more than 0.1.

19. The method according to claim 1, wherein the refractive index of said pigment and the refractive index of said lacquer differ by no more than 0.04.

20. The method according to claim 1, wherein said information carrier precursor further comprises an opaque element between the side of said receiving layer configuration nearer said support and said support.

21. The method according to claim 20, wherein said opaque element is non-contiguous with said receiving layer configuration and is preprinted with a security print.

22. The method according to claim 20, wherein said opaque element is non-contiguous with said receiving layer configuration and comprises polyvinyl chloride, polycarbonate or a polyester.

23. The method according to claim 1, wherein said pigment is an inorganic pigment.

24. The method carrier precursor according to claim 23, wherein said inorganic pigment is silica.

25. The method according to claim 1, wherein said information carrier is an identification card selected from the group consisting of an identity card, a security card, a driver's license card, a social security card, a health card, a membership card, a time registration card, a bank card, a pay card, a credit card and a passport page.

26. The method according to claim 1, wherein said information carrier is in the form of a flexible sheet.

27. The method according to claim 1, wherein said information carrier is an admission document.

28. A method for producing an information carrier comprising the steps of: (1) providing an information carrier precursor comprising: a rigid sheet or support; a receiving layer configuration comprising at least one constituent layer; and a layer or element capable of a human-readable or machine-readable change upon absorbing UV, visible or IR radiation, wherein at least one layer of said receiving layer configuration is opaque, porous, has the capability of being rendered substantially transparent upon penetration by a lacquer provided at the outermost surface of said receiving layer configuration and comprises at least one pigment and at least one binder; and in any order applying a third pattern to the outermost layer of said receiving layer configuration; realizing a permanent transparentization pattern by applying a lacquer pattern-wise or integrally to said receiving layer configuration; and writing with a light source a fourth pattern in said layer or element capable of human readable or machine-readable change upon absorbing UV, visible or IR radiation after transmission through at least part of the transparentized areas of said receiving layer configuration, with the proviso that said transparentization process is carried out prior to said writing step, thereby producing an information carrier.

29. The method according to claim 28, wherein said rigid sheet or support comprises at least one layer and/or a multilayered laminate or extrudate.

30. The method according to claim 28, wherein any of said patterns is a coloured pattern.

31. The method according to claim 28, wherein said light source is a laser.

32. The method according to claim 28, wherein said human-readable change is a density or colour change.

33. The method according to claim 28, wherein said machine-readable change is a change in light emission properties, in a conductive pattern, in an inductively readable pattern, in an electrical circuit or in a RF-readable entity.

34. The method according to claim 28, wherein said second or third pattern is applied using a conventional printing technique.

35. The method according to claim 28, wherein said pattern-wise transparentization is followed by applying a second or third pattern using a conventional printing process only to the opaque, porous parts of the outermost surface of the receiving layer configuration corresponding to the opaque, porous parts of said at least one opaque, porous layer remaining after pattern-wise transparentization.

36. The method according to claim 34, wherein said conventional printing technique is a non-impact or an impact printing technique.

37. The method according to claim 36, wherein said non-impact printing technique is selected from the group consisting of electrophotographic printing, electrophoretic printing and ink-jet printing.

38. The method according to claim 36, wherein said impact printing technique is selected from the group consisting of thermal dye transfer printing, screen printing, offset printing, gravure printing and flexographic printing.

39. The method according to claim 28, wherein, in the event of permanent pattern-wise transparentization of said at least one opaque, porous layer, the non-transparentized parts of said receiving layer configuration are penetrated with a non-transparentizing lacquer.

40. The method according to claim 28, wherein said layer or element capable of a human-readable or machine-readable change upon absorbing IR-radiation comprises a polymer resin optionally comprising an infra-red-absorbing dye or pigment.

41. The method according to claim 40, wherein said polymer resin is polycarbonate.

42. The method according to claim 28, wherein said layer or element capable of a human-readable or machine-readable change upon absorbing UV, visible or IR radiation comprises a polymer resin, a UV, visible or IR-absorbing dye or pigment and a heat-sensitive colour-forming system.

43. The method according to claim 42, wherein said heat-sensitive colour-forming system is a leuco-dye and an oxidizing agent or an acid in thermally working relationship therewith.

44. The method according to claim 42, wherein said heat-sensitive colour-forming system is a substantially light-insensitive organometallic compound and a reducing agent therefor in thermally working relationship therewith.

45. The method according to claim 28, wherein the refractive index of said pigment and the refractive index of said lacquer differ by no more than 0.1.

46. The method according to claim 28, wherein the refractive index of said pigment and the refractive index of said lacquer differ by no more than 0.04.

47. The method according to claim 28, wherein said information carrier precursor further comprises an opaque element between the side of said receiving layer configuration nearer said support and said support.

48. The method according to claim 47, wherein said opaque element is non-contiguous with said receiving layer configuration and is preprinted with a security print.

49. The method according to claim 47, wherein said opaque element is non-contiguous with said receiving layer configuration and comprises polyvinyl chloride, polycarbonate or a polyester.

50. The method according to claim 28, wherein said pigment is an inorganic pigment.

51. The method carrier precursor according to claim 50, wherein said inorganic pigment is silica.

52. The method according to claim 28, wherein said information carrier is an identification card selected from the group consisting of an identity card, a security card, a driver's license card, a social security card, a health card, a membership card, a time registration card, a bank card, a pay card, a credit card and a passport page.

53. The method according to claim 28, wherein said information carrier is in the form of a flexible sheet.

54. The method according to claim 28, wherein said information carrier is an admission document.
